(19) United States
(12) Patent Application Publication
(10) Pub. No.: US 2011/0208891 A1
(43) Pub. Date: Aug. 25, 2011

(54) METHOD AND APPARATUS FOR TRACKING TRANSACTIONS IN A MULTI-SPEED BUS ENVIRONMENT

(75) Inventor: Christopher Michael Meyers, Beaverton, OR (US)

(73) Assignee: Fresco Logic, Inc., Beaverton, OR (US)

(21) Appl. No.: 13/015,392

(22) Filed: Jan. 27, 2011

Related U.S. Application Data
(60) Provisional application No. 61/307,939, filed on Feb. 25, 2010.
(60) Provisional application No. 61/307,929, filed on Feb. 25, 2010.
(60) Provisional application No. 61/369,668, filed on Jul. 31, 2010.
(60) Provisional application No. 61/369,686, filed on Jul. 31, 2010.
(60) Provisional application No. 61/391,027, filed on Oct. 7, 2010.

(51) Int. Cl. G06F 13/20

(52) U.S. Cl. 710/313

(57) ABSTRACT

Systems and methods are provided to track the state of a data forwarding component, such as a USB transaction translator, included in a downstream hub within a multi-speed bus environment. The data forwarding component accommodates communication speed shifts at the hub. The method may comprise receiving a split packet request defining a transaction, performing a lookup in an associative array using hub-specific information provided in the split packet request to determine whether an identifier is allocated to the data forwarding component, and if it is determined, based on the lookup, that an identifier is allocated to the data forwarding component, storing state information associated with the split packet request. The associative array may include multiple identifiers, each of which has an associated state field configured to track information, such as the number of packets-in-progress and bytes-in-progress to a particular data forwarding component.

### RELATED APPLICATIONS

This application is a nonprovisional of and claims the benefit under 35 U.S.C. §119(e) of U.S. Provisional Patent Application No. 61/307,939, filed Feb. 25, 2010; U.S. Provisional Patent Application No. 61/307,929, filed Feb. 25, 2010; U.S. Provisional Patent Application No. 61/369,668, filed Jul. 31, 2010; U.S. Provisional Patent Application No. 61/369,686, filed Jul. 31, 2010; and U.S. Provisional Patent Application No. 61/391,027, filed Oct. 7, 2010, all of which are hereby incorporated by reference in their entireties.

### TECHNICAL FIELD

The field of this disclosure relates generally to serial bus data transfer and, in particular, to tracking the state of transaction translators in a multi-speed bus environment.

### BACKGROUND

Various interfaces have been designed to facilitate data exchange between a host computer and peripheral devices, such as keyboards, scanners, and printers. One common bus-based interface is the Universal Serial Bus (USB), which is a polled bus in which the attached peripherals share bus bandwidth through a host-scheduled, token-based protocol. The bus allows peripheral devices to be attached, configured, used, and detached while the host and other peripheral devices are operating.

Hubs provide additional connections to the USB. A hub typically includes an upstream facing port that communicates with the host (or an upstream hub) and one or more downstream facing ports, each of which can communicate with a peripheral device or downstream hub. Because the USB supports various data transfer rates (e.g., low-speed, full-speed, and high-speed), a hub typically includes one or more transaction translators to accommodate speed shifts at the hub. For example, if the hub communicates with the host at high-speed and has a low-speed or full-speed device connected to one of its downstream facing ports, the transaction translator converts special high-speed transactions called split transactions to low-speed or full-speed transactions so that data can be transferred between the host and the hub at high-speed. To accommodate speed shifts at the hub, a transaction translator includes buffers to hold transactions that are in progress. The buffers essentially provide an interface between the high-speed signaling environment and the low-speed and full-speed signaling environments.

Split transactions are scheduled by host software to communicate with low-speed and full-speed devices that are attached to downstream high-speed hubs. The split transactions convey isochronous, interrupt, control, and bulk transfers across the high-speed bus to hubs that have low-speed or full-speed devices attached to their ports. Periodic transactions, such as isochronous transfers with USB speakers or interrupt transfers with USB keyboards, have strict timing requirements. Thus, periodic transactions need to move across the high-speed bus, through the transaction translator, across the low-speed or full-speed bus, back through the transaction translator, and onto the high-speed bus in a timely manner. Non-periodic transactions, such as bulk transfers with USB printers or control transfers for device configuration, do not have strict timing requirements.

For periodic transactions, the host software initiates high-speed split transactions at the appropriate time intervals to help avoid buffer overflows and buffer underflows at the periodic transaction buffers within the transaction translator. The host software traditionally predetermines the dispatch schedule for scheduled periodic traffic destined for transaction translators from a computed total bandwidth based on a set of bandwidth allocation rules. The predetermined dispatch schedule is then typically communicated by firmware to host controller logic. If a new device requiring periodic transactions is connected to the bus, the host software determines a new dispatch schedule and communicates that new dispatch schedule to the host controller logic.

For non-periodic transactions, the host software traditionally uses simple try/retry flow control mechanisms (e.g., NAK handshakes) to manage the non-periodic transaction buffers within the transaction translator. In other words, the host software simply sends a high-speed split transaction to the hub and if there is available buffer space within the transaction translator, the hub accepts the transaction. If there is no available buffer space, the hub does not accept the transaction (and possibly issues a NAK handshake) and the host software resends the same high-speed split transaction at a later time. The try/retry approach for non-periodic transactions has a tendency to waste high-speed bus bandwidth and reduce bus efficiency when the hub does not accept a transaction (e.g., due to the non-periodic transaction buffers within the transaction translator being full).

### BRIEF DESCRIPTION OF THE DRAWINGS

FIG. 1 is a block diagram illustrating a plurality of devices attached to a host via an intermediate hub, according to one embodiment.

FIG. 2 is block diagram illustrating the interaction between various components within a hub that facilitate speed shifts when the hub communicates with a host controller over a high-speed bus and the hub communicates with a device over a low-speed or full-speed bus, according to one embodiment.

FIG. 3 is a diagram illustrating various packets sent to a hub in a start-split transaction, according to the prior art.

FIG. 4 is a diagram illustrating various packets sent to a hub in a complete-split transaction, according to the prior art.

FIG. 5 is a diagram illustrating the various fields of the start-split and complete-split token packets illustrated in FIGS. 3 and 4.

FIG. 6 is a block diagram illustrating additional details of the host controller of FIG. 1, according to one embodiment.

FIG. 7 is a block diagram illustrating additional details of the encapsulator of FIG. 1, according to one embodiment.

FIG. 8 is a block diagram illustrating additional details of the associative array of FIG. 1, according to one embodiment.

FIG. 9 is a state transition diagram illustrating various states of the management state machine of FIG. 8, according to one embodiment.

FIG. 10 is a block diagram illustrating additional details of the state memory of FIG. 7, according to one embodiment.

FIG. 11 is a block diagram illustrating low-speed, full-speed, and high-speed devices attached to a host via an intermediate high-speed hub incorporating multiple transaction translators and an intermediate high-speed hub incorporating a single transaction translator, according to one embodiment.

FIG. 12 is a flow chart of a method for updating state information associated with a transaction translator within a downstream hub, according to one embodiment.

FIG. 13 is a block diagram illustrating lookup logic used to perform a lookup in an associative array, according to one embodiment.

FIG. 14 is a logic diagram of one instance of the match logic of FIG. 13, according to one embodiment.

FIG. 15 is a block diagram illustrating the flow of a split packet request through a host controller and the interaction between various host controller components during the execution of a split packet request, according to one embodiment.

FIG. 16 is a block diagram illustrating additional details of the encapsulator of FIG. 15, according to one embodiment.

FIG. 17 is a simplified state diagram illustrating various states of the host controller state machine of FIG. 1, according to one embodiment.

### DETAILED DESCRIPTION

With reference to the above-listed drawings, this section describes particular embodiments and their detailed construction and operation. The embodiments described herein are set forth by way of illustration only and not limitation. Those skilled in the art will recognize in light of the teachings herein that, for example, other embodiments are possible, variations can be made to the example embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments. For example, additional details regarding the USB, split-transactions, low-speed transactions, full-speed transactions, high-speed transactions, hubs, and transaction translators can be found in the Universal Serial Bus Specification Revision 2.0, dated Apr. 27, 2000 (available from USB Implementers Forum, Inc. at http://www.usb.org/developers/docs/), which is hereby incorporated by reference in its entirety. In particular, Chapter 11 of the USB Specification Revision 2.0 provides additional details regarding hubs, transaction translators, and split-transactions. Additional details regarding the split-transaction protocol are described in section 8.4.2 of the USB Specification Revision 2.0.

As one skilled in the art will appreciate in light of this disclosure, certain embodiments may be capable of achieving certain advantages, including some or all of the following: (1) solving the data collection problem required to make real-time and immediate decisions for dispatching packets from a host to a downstream transaction translator; (2) by implementing a logic-based scheduler and flow control based upon state tracking information, a simpler hardware/software interface can be used for a host controller and it can eliminate a requirement for a driver to watch over all active periodic data pipes in order to build a timing map; (3) by freeing the driver from watching over periodic data pipes requirement, the logic-based scheduler and flow control based upon state tracking information also enables virtualization for the host operating system(s); (4) by using an associative array to track the state of each individual USB transaction translator, bus efficiency may be improved by preventing a situation that overwhelms the asynchronous capacity of each USB transaction translator; (5) by using an associative array to track the state of a transaction translator, a logic-based real-time management function can determine the dispatch timing of periodic packets to downstream transaction translators; (6) by tracking the state of transaction translators in a multi-speed bus environment, dispatch timing of packets from a host to downstream transaction translators can be improved; (7) by implementing a logic-based scheduler that determines dispatch timing of periodic packets in real-time, the driver can be freed from the task of timing map rebalance and transitioning from a first timing map (e.g., timing map A) to a second timing map (e.g., timing map B) during the attachment or removal of a new device to the bus; (8) providing a logic-based scheduler that determines dispatch timing of periodic packets in real-time facilitates rapid purge and recovery upon detection of an error with a downstream transaction translator; and (9) providing a host controller that dynamically determines a schedule (e.g., timing map) facilitates packing transactions close together in each frame to thereby maximize bus-idle time and yield opportunities for improved power savings by, for example, keeping a transceiver powered down for longer periods of time. These and other advantages of various embodiments will be apparent upon reading this document.

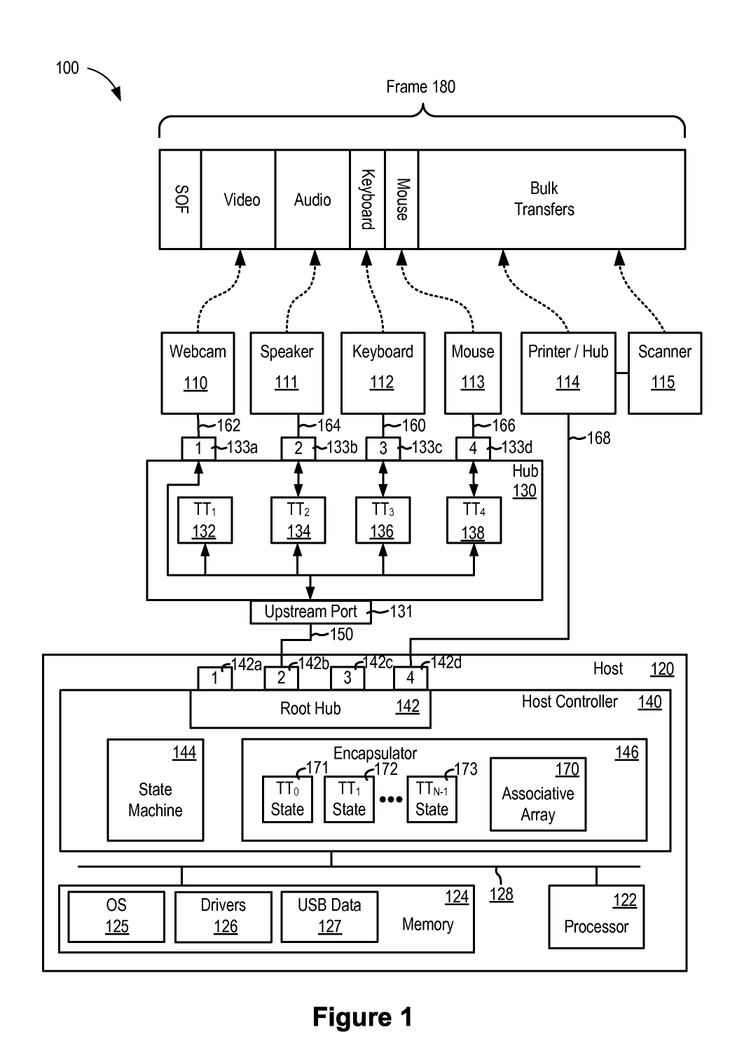

FIG. 1 is a block diagram of an example system 100 in which the state tracking methods described herein may be implemented. In the system 100, a plurality of devices 110-115 are attached to a host 120 via an intermediate hub 130. The hub 130 incorporates a plurality of transaction translators 132-138, which facilitate speed shifts between buses operating at different communication speeds or data transfer rates. For example, a first bus 150, which couples the hub 130 to the host 120, operates at a first communication speed (e.g., high-speed) while a second bus 160, which couples a keyboard 112 to the hub 130, operates at a second communication speed (e.g., low-speed or full-speed). An associative array 170 along with a plurality of state fields 171-173 are provided to track the state of transaction translators (e.g., transaction translators 134-138) within hubs that are in communication with the host 120. For example, the associative array 170 and the state fields 171-173 may be configured to track information such as the number of outstanding transactions and bytes-in-progress to downstream transaction translators.

According to one embodiment, the associative array 170 includes one ID for each transaction translator downstream from the host 120. Each ID element within the associative array 170 can be marked unused when there are no active entries and then it can be reused at another time by another transaction translator. In a preferred implementation, each associative array element ID tracks the number of outstanding transactions of each type (e.g., asynchronous and periodic), and each element ID tracks the number of bytes sent in each frame interval. A host controller 140 may use the tracked state information to make real-time and immediate determinations for dispatching packets (e.g., asynchronous and periodic packets) from the host 120 to downstream transaction translators.

Referring again to FIG. 1, the system 100 includes the host 120, which may be any computing device, such as a general-purpose computer, personal computer, embedded system (e.g., a system that is embedded into a complete device and is designed to perform a few dedicated functions or tasks), or other device (e.g., mobile phone, smartphone, or set-top box). The host 120 performs several functions, such as detecting the attachment and removal of devices (e.g., the devices 110-115 and the hub 130), managing control and data flow between the host 120 and the devices, collecting status and activity statistics, and providing power to the attached devices. The host 120 includes a processor 122 connected to a memory 124 and the host controller 140. The connection may be via a bus 128, such as a peripheral component interconnect express (PCle) bus, an advanced microcontroller bus architecture (AMBA) high-performance bus (AHB), an AMBA advanced trace bus (ATB), or a CoreConnect bus, or other communication mechanism, such as direct connections of a serial, parallel, or other type.

The processor 122 may be any form of processor and is preferably a digital processor, such as a general-purpose microprocessor or a digital signal processor (DSP), for example. The processor 122 may be readily programmable; hard-wired, such as an application specific integrated circuit (ASIC); or programmable under special circumstances, such as a programmable logic array (PLA) or field programmable gate array (FPGA), for example. Program memory for the processor 122 may be integrated within the processor 122, may be part of the memory 124, or may be an external memory. The processor 122 executes one or more programs to control the operation of the other components, to transfer data between components, to associate data from the various components together (preferably in a suitable data structure), to perform calculations using the data, to otherwise manipulate the data, and to present results to the user. For example, the processor 122 preferably executes software to manage interactions between attached devices and host-based device software, such as device enumeration and configuration, isochronous and asynchronous data transfers, power management, and device and bus management information.

The memory 124 may comprise any suitable machine readable medium, such as random access memory (RAM), read only memory (ROM), flash memory, and EEPROM devices, and may also include magnetic or optical storage devices, such as hard disk drives, CD-ROM drives, and DVD-ROM drives. In certain embodiments, the host controller 140 is a shared memory host controller in which the memory 124 (e.g., RAM) is shared between the host controller 140 and the processor 122. In addition, or alternatively, an interface may be coupled to the bus 128 so that memory 124 or another memory, such as flash memory or a hard disk drive, are accessible locally or accessible remotely via a network.

Operating system (OS) 125 and drivers 126 may be stored in memory 124 or in another memory that is accessible to the host 120. The drivers 126 serve as the interface between the operating system 125 and the various hardware components that are included in the host 120, such as the memory 124 and the host controller 120, and other components that may be included in the host 120, such a display driver, network interface, and input/output controller. For example, for each hardware component included in the host 120, a driver for that component may be stored in memory 124. Data 127 may also be stored in memory 124 or in another memory that is accessible to the host 120. The data 127 may include data awaiting transfer to one of the devices 110-115, such as audio output destined for a speaker 111 or print data destined for a printer 114. The data 127 may also include data received from one of the devices 110-115, such as video data from a webcam 110, user input data from the keyboard 112 or a mouse 113, or image data from a scanner 115.

The host 120 interacts with devices 110-115 through the host controller 140, which functions as an interface to the host 120 and allows for two-way communication with the attached devices (e.g., the devices 110-115 and the hub 130). Various devices may be coupled to the host 120 via the host controller 140, such as the webcam 110, speaker 111, keyboard 112, mouse 113, printer 114, and scanner 115. Other devices that may be coupled to the host controller 140 include, for example, cameras, MP3 players, and other input devices such as a pen and tablet and a trackball. Although only one host controller is illustrated in FIG. 1, multiple host controllers may be included in the host 120. In addition, each of the devices 110-115 may serve as a hub for other devices. For example, the printer 114 provides hub functionality so that another device, such as the scanner 115, can be coupled to the host 120 via a hub within the printer 114. Further, external hubs, such as the hub 130, may be coupled to the host controller 140.

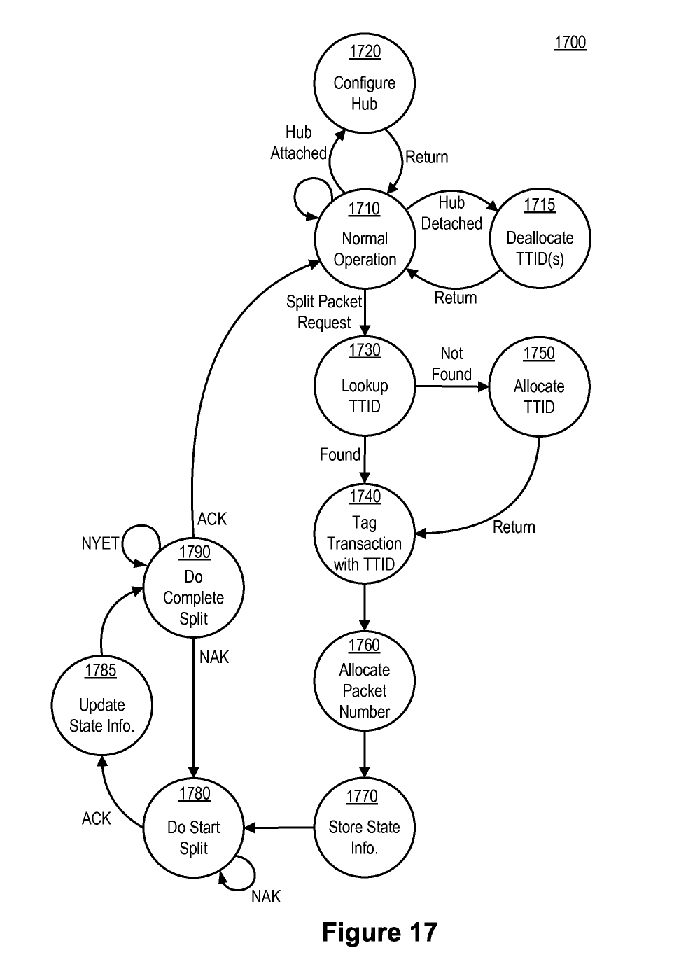

In the embodiment illustrated in FIG. 1, the host controller 140 includes a root hub 142, a set of state machines 144, and an encapsulator 146. The root hub 142 is directly attached to or embedded in the host controller 140 and includes one or more root ports, such as root ports 1-4 (which are labeled 142a-142d in FIG. 1). The root hub 142 provides much of the same functionality as an externally connected hub, such as the hub 130, but the root hub 142 is integrated within the host 120 and the hardware and software interface between the root hub 142 and the host controller 140 is defined by the specific hardware implementation. The set of state machines 144 manage the attachment and removal of devices to the system 100 and manage the traversal of data between the host 120 and attached devices (e.g., the devices 110-115 and the hub 130). Additional details of one of the state machines in the set of state machines 144 will be described with reference to FIG. 17.

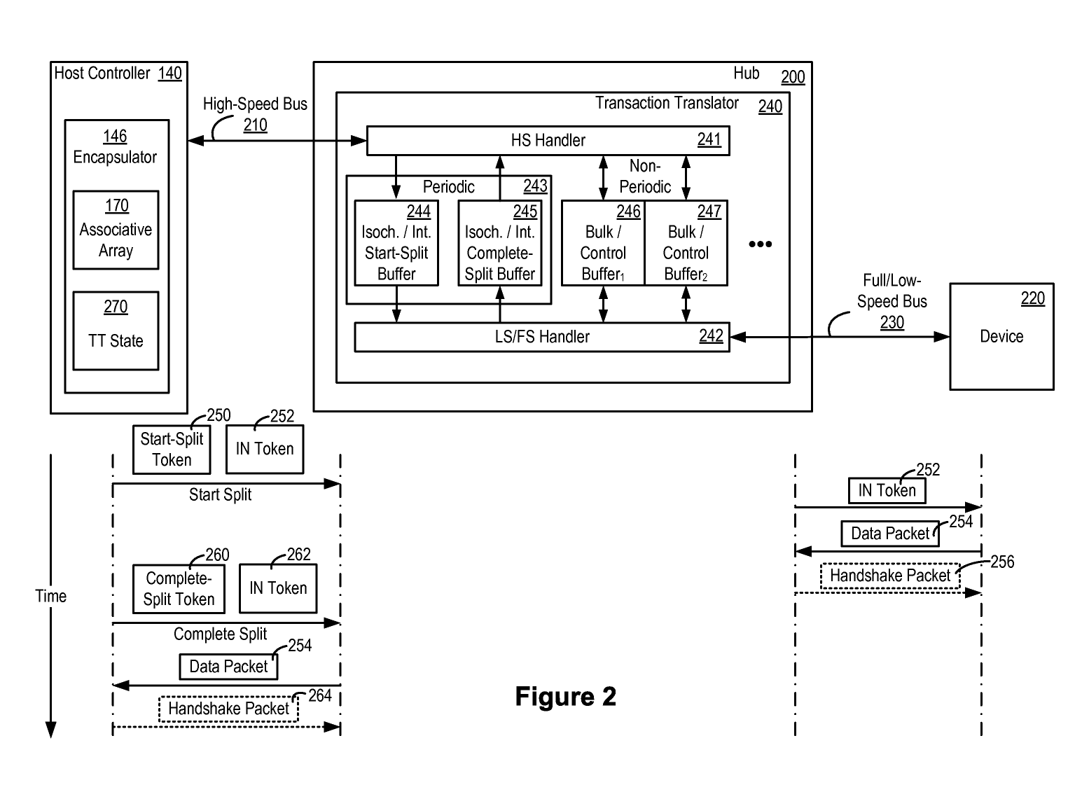

According to one embodiment, the encapsulator 146 is configured to generate split transactions, which are special transactions that are generated and scheduled by the host 120 to facilitate speed shifts between buses operating at different communication speeds or data transfer rates, such as when the host 120 communicates with low-speed and full-speed devices that are attached to downstream high-speed hubs. The encapsulator 146 builds fields around a normal packet (e.g., an IN or OUT token packet) and collects information used to execute the normal packets. The information collected by the encapsulator 146 includes the state of transaction translators (e.g., transaction translators 134-138) within hubs that are in communication with the host 120. The associative array 170 and the plurality of state fields 171-173 are configured to store state information concerning various transaction translators, such as the number of outstanding transactions and bytes-in-progress to downstream transaction translators. The state information tracked using the associative array 170 and the plurality of state fields 171-173 may be used by the host controller 140 to dispatch packets from the host 120 to downstream transaction translators. For example, the tracked state information may be used by the host controller 140 to help avoid buffer overflows and buffer underflows at the transaction buffers within the transaction translators. According to one embodiment, the encapsulator 146 is implemented in hardware, but the encapsulator 146 may be implemented in any combination of hardware, firmware, or software. Additional details regarding the encapsulator 146 will be described with reference to FIGS. 2 and 6-16.

The host controller 140 may be implemented in any combination of hardware, firmware, or software. According to a preferred embodiment, the host controller 140 implements a USB protocol, such as one or more of USB 1.0 described in Universal Serial Bus Specification Revision 1.1, dated September 1998, USB 2.0 described in Universal Serial Bus Specification Revision 2.0, dated Apr. 27, 2000, and USB 3.0 described in Universal Serial Bus 3.0 Specification Revision 1.0, dated Nov. 12, 2008, all of which are available from USB Implementers Forum, Inc. at http://www.usb.org/developers/docs/ and are hereby incorporated by reference in their entireties. According to other embodiments, the host controller 140 implements other protocols, such as a future USB version or anther protocol that imposes a tiered ordering on a star topology to create a tree-like configuration.

Hosts according to other embodiments may have less than all of the components illustrated in FIG. 1, may contain other components, or both. For example, the host 120 may include a number of other components that interface with one another via the bus 128, including a display controller and display device, an input controller, and a network interface. The display controller and display device may be provided to present data, menus, and prompts, and otherwise communicate with a user via one or more display devices. The network interface may be provided to communicate with one or more hosts or other devices. The network interface may facilitate wired or wireless communication with other devices over a short distance (e.g., Bluetooth™) or nearly unlimited distances (e.g., the Internet). In the case of a wired connection, a data bus may be provided using any protocol, such as IEEE 802.3 (Ethernet). A wireless connection may use low or high powered electromagnetic waves to transmit data using any wireless protocol, such as Bluetooth™, IEEE 802.11b/g/n (or other WiFi standards), infrared data association (IrDa), and radiofrequency identification (RFID).

An upstream port 131 of the hub 130 is coupled to port 2 (142b) of the root hub 142 via the first bus 150. As used herein, upstream refers to the port on a hub that is closest to the host in a communication topology sense and downstream refers to the port on the hub that is furthest from the host in a communication topology sense.

The hub 130 incorporates transaction translators 132, 134, 136, and 138, which facilitate speed shifts between buses operating at different communication speeds or data transfer rates. For example, as illustrated in FIG. 1, several devices are coupled to downstream ports 1-4 (133a-133d) via a respective bus 160-166. The speaker 111, keyboard 112, and mouse 113 communicate with the hub 130 at a communication speed that is less than the speed at which the hub 130 communicates with the host 120. For example, the speaker 111 may communicate with the hub 130 at full-speed and the keyboard 112 and mouse 113 may communicate with the hub 130 at slow-speed or full-speed while the hub 130 communicates with the host 120 at high-speed. Transaction translators 134-138 are utilized to translate transactions as the transactions transition between the slow-speed or full-speed signaling environment and the high-speed signaling environment. In contrast, the webcam 110 communicates with the hub 130 at a speed (e.g., high-speed) that is the same or substantially similar to the speed at which the hub 130 communicates with the host 120. Because there is no speed shift at the hub 130, data flowing between the webcam 110 and the host 120 bypasses the transaction translator 132. The transaction translators provide a mechanism to support slower devices (e.g., low-speed or full-speed devices) behind the hub 130, while all device data between the host 120 and the hub 130 is transmitted at a faster speed (e.g., high-speed).

In the example configuration illustrated in FIG. 1, the first bus 150 operates at a first communication speed while the second bus 160, a third bus 164, and a fourth bus 166 operate at a second communication speed that is different from the first communication speed. A fifth bus 162 and a sixth bus 168, which couples the printer 114 having an integral hub to port 4 (142d) of the root hub 142, also operate at the first communication. According to one embodiment, the first communication speed corresponds to a USB high-speed data transfer rate of approximately 480 megabits per second and the second communication speed corresponds to one of a USB low-speed data transfer rate of approximately 1.5 megabits per second or a USB full-speed data transfer rate of approximately 12 megabits per second. However, the first and second communication speeds may correspond to other data transfer rates. For example, the first communication speed may correspond to a USB super-speed data transfer rate of approximately 5 gigabits per second and the second communication speed may correspond to one of a USB high-speed, full-speed, or low-speed data transfer rate.

The devices (e.g., devices 110-115 and the hub 130) in communication with the host 120 share bus bandwidth. FIG. 1 illustrates a frame 180 depicting a variety of potential transactions that could be performed during a single frame (e.g., a one millisecond frame or microframe). The frame 180 illustrated in FIG. 1 is a contrived example to illustrate the shared nature of a frame. Not every device 110-115 will necessarily transfer data during each frame. For example, host software might poll the keyboard 112 every nth frame to check for keystrokes. Some devices require bandwidth every frame (e.g., isochronous transactions for speaker 111) while other devices transfer large blocks of data that do not have strict timing requirements (e.g., asynchronous transfers for the printer 114). When an application requires large amounts of bandwidth every frame, little bandwidth may be left for bulk transfers (e.g., for the printer 114 or scanner 115), which may, for example, slow or even stop the transfer of data to the printer 114. If the host controller 140 tries to poll the keyboard 112 when the buffer(s) within the transaction translator 136 are full, the hub 130 will not accept the transaction and the host controller 140 resends the same transaction during another frame, which may further slow the transfer of data to the printer 114, for example. By tracking the state of the transaction translators 134-138 within the hub 130 (it may not be necessary to track the state of the transaction translator 132 because the data destined for the webcam 110 bypasses the transaction translator 132), the host controller 140 can determine when the buffer(s) within the transaction translator 136 are full, for example, and refrain from sending further transactions until the buffer(s) are ready to accept additional data. Thus, tracking the state of the transaction translators helps improve bus efficiency, which may speed up the transfer of data to the printer 114, for example.

FIG. 2 is block diagram illustrating the interaction between various components within a hub 200 that facilitate speed shifts when the hub 200 communicates with the host controller 140 over a high-speed bus 210 and the hub 200 communicates with a device 220 over a low-speed or full-speed bus 230, according to one embodiment. As described with reference to FIG. 1, the host controller 140 implements a USB protocol, such as one or more of USB 1.0, USB 2.0, and USB 3.0. The USB is polled bus in which the host controller 140 initiates data transfers. The data transfers involve the transmission of packets, which are bundles of data organized in a group for transmission. A transaction begins when the host controller 140 (e.g., on a scheduled basis) sends a token packet that identifies what transaction is to be performed on the bus. For example, the token packet may describe the type and direction of transaction, the device address, and endpoint number. The device that is addressed (e.g., the device 220) selects itself by decoding the appropriate address fields. In a given transaction, data is transferred either from the host to a device (an OUT transfer) or from a device to the host (an IN transfer). The direction of data transfer is specified in the token packet. The source of the transaction then sends a data packet or indicates it has no data to transfer. The destination (e.g., the device 220) may respond with a handshake packet indicating whether the transfer was successful.

The hub 200 includes one or more transaction translators 240 to facilitate speed shifts at the hub 200. The transaction translator 240 is responsible for participating in high-speed split transactions on the high-speed bus 210 via its upstream facing port and issuing corresponding low-speed or full-speed transactions on its downstream facing ports that are operating at low-speed or full-speed. The transaction translator 240 acts as a high-speed function on the high-speed bus 210 and performs the role of a host controller for its downstream facing ports that are operating at low-speed or full-speed. The transaction translator 240 includes a high-speed handler 241 to handle high-speed transactions. The transaction translator 240 also includes a low-speed/full-speed handler 242 that performs the role of a host controller on the downstream facing ports that are operating at low-speed or full-speed.

The transaction translator 240 includes buffers 244-247 to hold transactions that are in progress. The buffers 244-247 (e.g., first-in, first-out (FIFO) buffers) provide the connection between the high-speed handler 241 and the low-speed/full-speed handler 242. The high-speed handler 241 accepts high-speed start-split transactions or responds to high-speed complete-split transactions. The high-speed handler 241 stores the start-split transactions in one of buffers 244, 246, or 247 so that the low-speed/full-speed handler 242 can execute the transaction on the low-speed or full-speed bus 230. The transaction translator 240 includes a periodic buffer section 243, which includes a start-split buffer 244 and a complete-split buffer 245 for isochronous or interrupt low-speed or full-speed transactions, and two non-periodic buffers 246 and 247 for bulk or control low-speed or full-speed transactions. Transaction translators according to other embodiments may include fewer or additional buffers.

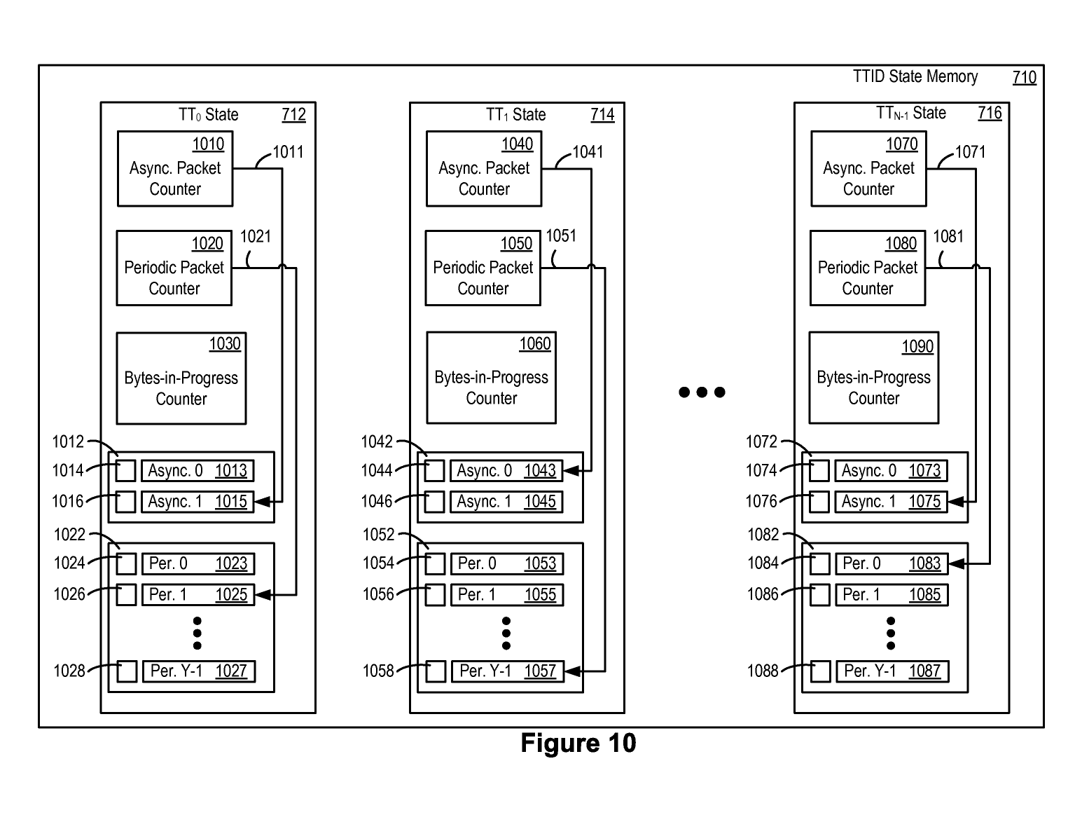

The start-split buffer 244 stores isochronous or interrupt start-split transactions. The high-speed handler 241 fills the start-split buffer 244 and the low-speed/full-speed handler 242 reads data from the start-split buffer 244 to issue corresponding low-speed or full-speed transactions to low-speed or full-speed devices attached on downstream facing ports. The complete-split buffer 245 stores the results (e.g., data or status) of low-speed or full-speed transactions. The low-speed/full-speed handler 242 fills the complete-split buffer 245 with the results of the low-speed or full-speed transactions and the high-speed handler 241 empties the complete-split buffer 245 in response to a complete-split transaction from the host controller 140. The start-split and complete-split buffers 244 and 245 may be sized so that each buffer stores multiple transactions. According to one embodiment, the start-split and complete-split buffers 244 and 245 are sized to accommodate sixteen simultaneous periodic transactions but not necessarily the data for those sixteen transactions at one time. For example, the start-split buffer 244 may be sized to accommodate four data packets (e.g., for OUT transactions) plus sixteen low-speed or full-speed tokens (e.g., for IN or OUT transactions) for four microframes, or approximately 1008 bytes (4*188 bytes for the data packets plus 16*4*4 bytes for the headers). In other words, the start-split buffer 244 is sized to buffer four microframes of data, according to one embodiment. The complete-split buffer 245 may be sized to accommodate two data packets (e.g., for IN transactions) plus sixteen low-speed or full-speed tokens (e.g., for IN or OUT transactions) for two microframes, or approximately 504 bytes (2*188 bytes for the data packets plus 16*2*4 bytes for the headers). In other words, the complete-split buffer 245 is sized to buffer two microframes of data, according to one embodiment. The size of the start-split and complete-split buffers 244 and 245 may be used as a basis for the number of periodic packets to track for each transaction translator, which will be discussed in more detail below with reference to FIG. 10.

The transaction translator 240 illustrated in FIG. 2 includes two non-periodic buffers 246 and 247, each of which is sized to store a single transaction. Thus, the transaction translator 240 can only support two bulk or control low-speed or full-speed transactions concurrently. Transaction translators according to other embodiments may include more than two non-periodic buffers and may be sized to store more than a single transaction. The non-periodic buffers 246 and 247 are configured to store both start-split and complete-split transaction data. The high-speed handler 241 fills one of the non-periodic buffers 246 and 247 with start splits. The low-speed/full-speed handler 242 reads data from the filled buffer to issue corresponding low-speed or full-speed transactions to low-speed or full-speed devices attached on downstream facing ports and then uses the same buffer to hold any results (e.g., data, a handshake, or a timeout). The host controller 140 fetches the results of the transaction from the non-periodic buffer by issuing a complete-split transaction.

When a low-speed or full-speed device (e.g., the device 220) is attached to a high-speed hub (e.g., the hub 200), the encapsulator 146 issues split transactions to facilitate speed shifts between the two signaling environments. Split transactions allow the host controller 140 to initiate a low-speed or full-speed transaction using a high-speed transaction and then continue with other high-speed transactions without having to wait for the low-speed or full-speed transaction to proceed and complete at a slower speed. Split transactions effect data transfer from the host to a device (i.e., an OUT transfer) or from a device to the host (i.e., an IN transfer).

An example of the host controller 140 retrieving data from the device 220 (i.e., an IN transfer) is illustrated in FIG. 2. For an IN transaction, the encapsulator 146 sends to the hub 200 via the high-speed bus 210 a preliminary message called a start-split transaction that includes a start-split token 250 and an IN token 252. The IN token 252 is the low-speed or full-speed transaction that will be executed on the low-speed or full-speed bus 230. In other words, the encapsulator 146 encapsulates the low-speed or full-speed transaction so that the low-speed or full-speed transaction can be sent over the high-speed bus 210. After receiving the start-split token 250 and IN token 252, the high-speed handler 241 stores all or a portion of the start-split token 250 and IN token 252 in the start-split buffer 244. According to a preferred embodiment, the start-split token 250 and the IN token 252 are decoded and stored in the hub buffer but the start-split token 250 and the IN token 252 may not be stored exactly as they appear on the high-speed bus 210. For example, the hub address may not be stored after it is verified that the hub address matches the address of the hub 200. Similarly, the five-bit cyclic redundancy check (CRC) may not be stored after the hub 200 has validated the token integrity. The low-speed/full-speed handler 242 pulls the start-split transaction from the buffer 244 and coordinates when the IN token 252 is released onto the low-speed or full-speed bus 230, which transfers the IN token 252 to the device 220 at the appropriate speed (e.g., low-speed or full-speed).

In response to receiving the IN token 252, the device 220 sends an appropriate data packet 254 back over the low-speed or full-speed bus 230 to the hub 200. After receiving the data packet 254, the low-speed/full-speed handler 242 stores the data packet 254 in the complete-split buffer 245. If uncorrupted data is received (and the endpoint type is not isochronous), the low-speed/full-speed handler 242 preferably returns an acknowledgement or handshake packet 256 to the device 220 (e.g., to prevent the device 220 from timing out). If the endpoint type is isochronous, an acknowledgement or handshake packet is not returned.

At an appropriate time after sending the start-split token 250 and the IN token 252 (e.g., after the host controller 140 expects the data packet 254 to have been stored in the compete-split buffer 245), the encapsulator 146 sends to the hub 200 a complete-split transaction that includes a complete-split token 260 and an IN token 262. After receiving the complete-split transaction, the high-speed handler 241 retrieves the data packet 254 from the complete-split buffer 245 and forwards the data packet 254 to the host controller 140 via the high-speed bus 210. The host controller 140 may optionally return an acknowledgement or handshake packet 264 to the hub 200, which is not forwarded beyond the hub 200. The host-generated handshake packet 264 might not arrive at the device 220 before the device 220 times out, so the low-speed/full-speed handler 242 sends its own handshake 256 after receiving the data packet 254 from the device 220 to satisfy the device 220 (e.g., the “true” handshake packet 264 is not forwarded beyond the hub 200).

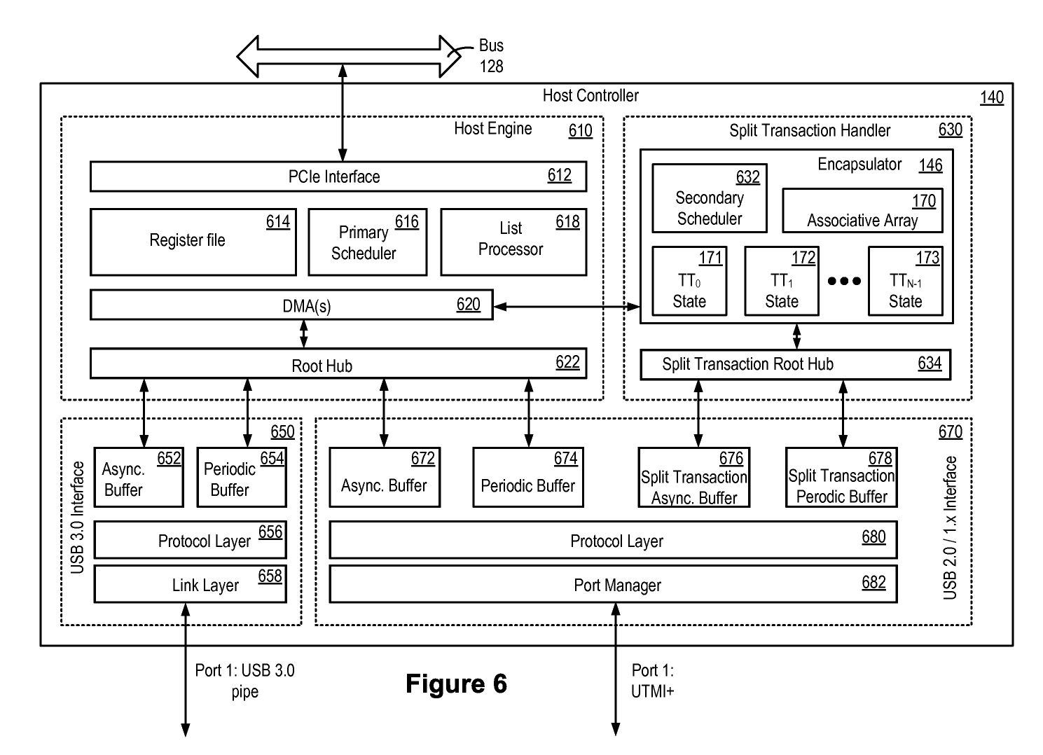

The encapsulator 146 updates state information associated with the transaction translator that will execute the low-speed or full-speed transaction to reflect the split transaction that will be sent to the hub 200. For example, the encapsulator 146 updates a state field 270, which is associated with the transaction translator 240 through the associative array 170, to reflect a start-split transaction destined for the transaction translator 240. Likewise, the encapsulator 146 updates the state field 270 to reflect the state of the transaction translator 240 when the encapsulator 146 issues a complete-split transaction. The state information stored in the state filed 270 may include, for example, data concerning a total number of periodic or non-periodic packets-in-progress, a total number of bytes-in-progress, the execution status of the packets (e.g., if multiple complete-splits are used to retrieve the data from the device 220, the state filed 270 may indicate whether the transaction translator 240 is in the beginning, middle, or end of the expected data transfer from the device 220). Armed with the tracked state information, the encapsulator 146 can avoid buffer overflows and buffer underflows at the transaction buffers within the transaction translators (e.g., buffers 244-247 within the transaction translator 240). Additional details regarding tracking the state of a transaction translator via the associative array 170 will be described with reference to FIGS. 6-16.

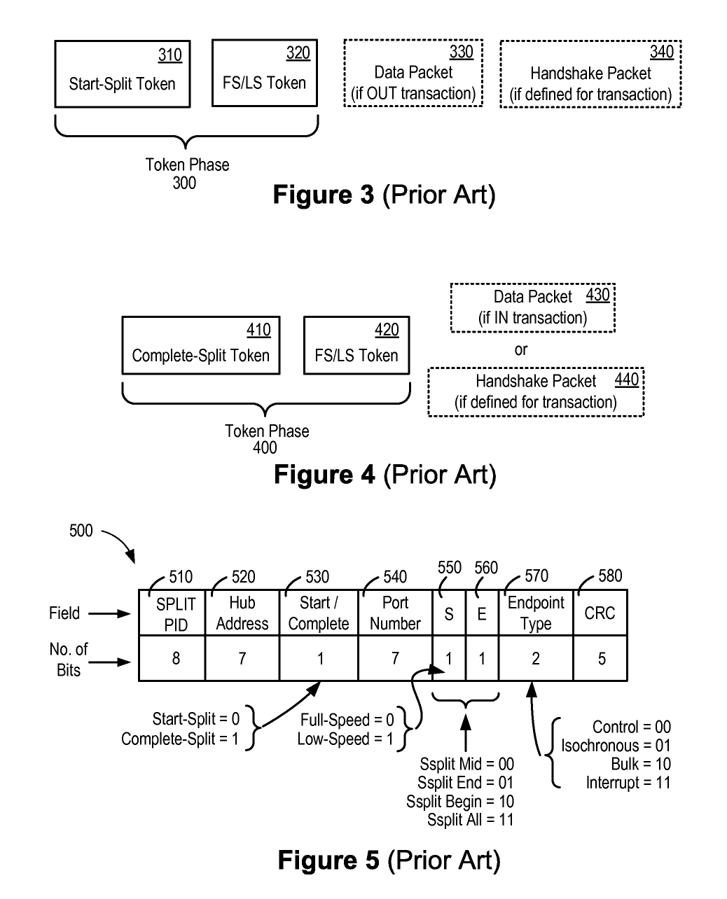

A high-speed split transaction includes one or more start-split transactions and occasionally includes one or more complete-split transactions. FIG. 3 is a block diagram illustrating various packets sent to a hub in a start-split transaction, according to the prior art. A token phase 300 of a start-split transaction includes a start-split token 310 and a low-speed or full-speed token 320 (e.g., an IN or OUT token). Depending on the direction of data transfer and whether a handshake is defined for the transaction type, the token phase 300 may optionally be followed by a data packet 330 and a handshake packet 340. FIG. 4 is a block diagram illustrating various packets sent to a hub in a complete-split transaction, according to the prior art. A token phase 400 of a complete-split transaction includes a complete-split token 410 and a low-speed or full-speed token 420 (e.g., an IN or OUT token). Depending on the direction of data transfer and the transaction type, a data packet 430 or a handshake packet 440 may optionally follow the token phase 400.

FIG. 5 is a block diagram illustrating the various fields of a SPLIT token packet 500, according to the prior art. The SPLIT token packet 500 is used to start and complete a split transaction and a start/complete field 530 defines whether the SPLIT token packet 500 is a start-split token packet (e.g., packet 310 of FIG. 3) or a complete-split token packet (e.g., packet 410 of FIG. 4). The SPLIT token packet 500 include a number of fields, including a SPLIT PID field 510, a hub address field 520, the start/complete field 530, a hub port number field 540, a speed field 550, a end field 560, an endpoint type field 570, and a cyclic redundancy check (CRC) field 580. The SPLIT PID field 510 is an eight-bit packet identifier field that includes a four-bit code that indicates that a packet is a SPLIT token packet. The hub address field 520 is a seven-bit field that indicates a device address of a hub that should decode and process the split transaction. The start/complete field 530 defines whether a packet is a start-split packet or a complete-split packet. The hub port field 540 indicates a port number of a hub that the split transaction is targeting. Thus, a device can be targeted by the host controller 140 using the hub address field 520 and the hub port field 540.

The speed field 550 indicates the speed of a transaction (e.g., low-speed or full-speed) when a control, interrupt, or bulk transaction is performed with a target endpoint. During isochronous OUT start-split transactions, the speed field 550 and the end field 560 together specify the type of start-split packet being issued by the host controller 140. Different start-split packets are used to indicate whether another start-split transaction will follow. For example, according to one embodiment, the maximum amount of data the host controller 140 delivers during a start-split transaction is 188 bytes, which should be enough data to keep the low-speed/full-speed bus busy for one microframe. In other words, to help ensure that an isochronous OUT transaction runs smoothly, 188 byes of data should be delivered to the buffer (e.g., buffer 244 in FIG. 2) during each microframe. Data payloads that are larger than 188 bytes may require two or more microframes to complete.

If the start and end fields 550 and 560 specify a start-split all transaction, all data needed to complete the transaction is being delivered in a single start-split transaction (i.e., the data payload is 188 bytes or less). If the start and end fields 550 and 560 specify a start-split begin transaction, the start-split packet is the beginning of a multiple start-split packet sequence and one or more additional start-split packets will follow in subsequent microframes. If the start and end fields 550 and 560 specify a start-split middle transaction, the start-split packet is the middle of a multiple start-split packet sequence and at least one more start-split packet will follow in a subsequent microframe. If the start and end fields 550 and 560 specify a start-split end transaction, the start-split packet is the end of a multiple start-split packet sequence and no additional start-split packets (relating to the same start-split packet sequence) will follow in subsequent microframes.

The endpoint type field 570 is a two-bit field that indicates the endpoint type (e.g., interrupt, isochronous, bulk, or control). Control transfers are used, for example, to configure a device at attach time and can be used for other device-specific purposes, including control of other pipes on the device. Bulk data transfers are generally generated or consumed in relatively large and bursty quantities and have wide dynamic latitude in transmission constraints. Interrupt data transfers are used for timely but reliable delivery of data, such as, for example, characters or coordinates with human-perceptible echo or feedback response characteristics. Interrupt data transfers generally occupy a prenegotiated amount of bus bandwidth. Isochronous data transfers generally occupy a prenegotiated amount of bus bandwidth with a prenegotiated delivery latency (e.g., for so called streaming real time transfers). The cyclic redundancy check (CRC) field 580 is a five-bit CRC that corresponds to the nineteen bits of the SPLIT token packet that follow the SPLIT PID field 510.

FIG. 6 is a block diagram illustrating additional details of the host controller 140 of FIG. 1, according to one embodiment. The host controller 140 illustrated in FIG. 6 implements the USB 2.0 and USB 3.0 protocols using a host engine 610, a split transaction handler 630, a USB 3.0 interface 650, and a USB 2.0 and 1.x interface 670. Host controllers according to other embodiments may include fewer than all of the components illustrated in FIG. 6, may include other components, or both. In addition, host controllers according to other embodiments may implement any combination of the USB 1.0, USB 2.0, and USB 3.0 protocols or other protocols, such as a future USB version.

The host engine 610 includes a bus interface 612 configured to communicatively couple other components of the host 120 (FIG. 1), such as the processor 122 and the memory 124, to the host controller 140 via the bus 128. According to one embodiment, the bus interface 612 is configured to communicate over the bus 128 using the PCIe protocol. To initiate data transfers to or from a target device (e.g., devices 110-115 in FIG. 1), system software, such as the drivers 126 (e.g., USB device drivers or client drivers) or the OS 125 (FIG. 1), issues transaction requests to the host engine 610 via the bus 128. For example, a USB keyboard driver may issue a transaction request that indicates how often the keyboard should be polled to determine if a user has pressed a key and supplies the location of a memory buffer into which data from the keyboard is stored. According to one embodiment, the system software issues a transaction request by generating or setting up a linked list or ring of data structures in system memory (e.g., the memory 124 in FIG. 1) and writing data to a doorbell register in a register file 614, which alerts a primary scheduler 616 and a transfer ring manager (TRM) or list processor 618 that an endpoint (e.g., a uniquely addressable portion of a device that is the source or sink of data between the host and device) needs servicing. The ring of data structures may include one or more transfer request blocks (TRBs). Individual transfer request blocks may include one or more fields specifying, for example, the device address, the type of transaction (e.g., read or write), the transfer size, the speed at which the transaction should be sent, and the location in memory of the data buffer (e.g., where data from the device should be written or where data destined for the device can be read from). The register file 614 also stores data used to control the operation of the host controller 140, data regarding the state of the various ports associated with interfaces 650 and 670, and data used to connect and establish a link at the port level.

After the doorbell has been rung (i.e., after the data has been written to the doorbell register), the primary scheduler 616 and the list processor 618 work together to move data between the host and the device. The primary scheduler 616 determines when the host controller 140 will move data between the host and the device and the list processor 618 determines what data will be transferred based the information included in the transaction request. The list processor 618 also determines where the data to be transferred is stored, whether the data should be transferred via the USB 3.0 interface 650 or the USB 2.0/1.x interface 670, the speed at which the data should be transferred (e.g., low-speed, full-speed, high-speed, or super-speed), and whether the transaction includes a split transaction. After the primary scheduler 616 determines when the data will be moved, the primary scheduler sends a request to the list processor 618 to service the endpoint.

The list processor 618 processes the transaction request by walking through the ring of transfer request blocks and executing the individual transfer request blocks by handing them off to a direct memory access (DMA) engine(s) 620. The DMA engine 620 pairs up the individual transfer request blocks with any necessary data movement and passes the transaction identified by the transfer request block and any associated data to a root hub 622. According to one embodiment, the DMA engine 620 comprises an inbound DMA engine for inbound data transfers and an outbound DMA engine for outbound data transfers. The root hub 622 routes the transaction and any associated data to an appropriate buffer 652, 654, 672 or 674 for an appropriate port (e.g., port 1-4) depending on which port the device is connected, whether the transaction is a USB 1.x, 2.0, or 3.0 transaction, and whether the transaction is a periodic or asynchronous transfer. For example, if the device to which the transaction relates is connected to port 1 and the transaction involves a high-speed asynchronous transaction, the transaction and any associated data is routed by the root hub 622 into the asynchronous buffer 672. A protocol layer 680 and port manager 682 pull the transaction and any associated data from the asynchronous buffer 672 at the appropriate time for transmission over the downstream bus. After the device responds (e.g., with image data from a scanner or user input data from a keyboard, for example), the response moves back through the host controller 140 in the reverse direction along a similar path. For example, the response moves from the port manager 682 up through the protocol layer 680, into the asynchronous buffer 672, and eventually onto the bus 128 via the root hub 622, the DMA engine 620, the list processor 618, and the bus interface 612. After the list processor 618 receives the response, the list processor 618 inspects the results and handles any actions specified in the transaction ring, such as asserting an interrupt.

While the host controller 140 only illustrates a single port (port 1) in the USB 3.0 interface 650 and a single port (port 1) in the the USB 2.0/1.x interface 670, the interfaces 650 and 670 include multiple ports (e.g., ports 1-4). Each port of the USB 3.0 interface 650 may include asynchronous and periodic buffers 652 and 654 (e.g., FIFO buffers) to store transactions and any associated data and a protocol layer 656 and a link layer 658 to implement the USB 3.0 protocol. Each port of the USB 2.0/1.x interface 670 may include asynchronous and periodic buffers 672 and 674 (e.g., FIFO buffers) for non-split transactions and asynchronous and periodic buffers 676 and 678 (e.g., FIFO buffers) for split transactions. Each port of the USB 2.0/1.x interface 670 may also include the protocol layer 680 and port manager 682 to implement the USB 2.0 and USB 1.0 protocols.

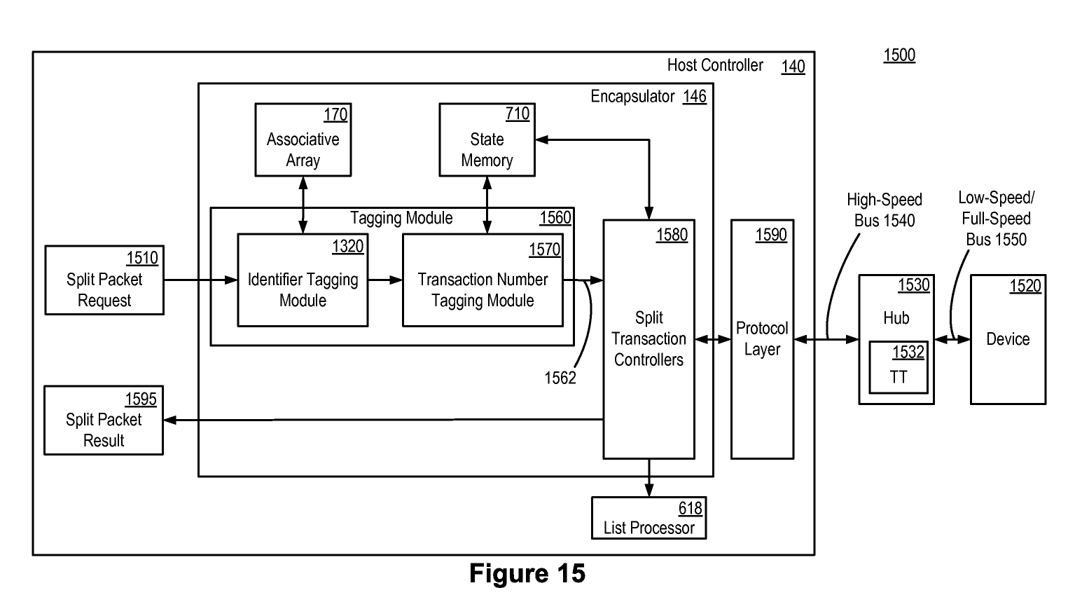

Split transactions take a different path through the host controller 140. After the system software sets up the transfer request block rings and rings the doorbell, the primary scheduler 616 initiates a transaction request by sending a request to the list processor 618 to service the endpoint. If the list processor 618 determines that the transaction request involves a split transaction destined for a full-speed or low-speed device attached to a hub operating at high-speed, the list processor 618 executes the split transaction by generating a split packet request (e.g., from state and/or data information fields stored in a control memory associated with the list processor 618) and handing the split packet request off to the DMA engine 620, which pairs the split packet request up with the necessary data movement and passes the split packet request and any associated data to the encapsulator 146. The split packet request generated by the list processor 618 generally includes more data information fields (e.g., that are pulled from the control memory) than the transfer request block. The fields that make up a split packet request according to one embodiment are shown in Table 3, below. According to one embodiment, the split packet request is not immediately paired up with the necessary data movement. Instead, the encapsulator 146 (e.g., split transaction controllers within the encapsulator 146) requests, at the appropriate time, the list processor 618 to resend the split packet request so that the DMA engine 620 can pair the split packet request up with the necessary data movement. Additional details regarding re-requesting the split packet request are described with reference to FIG. 15.

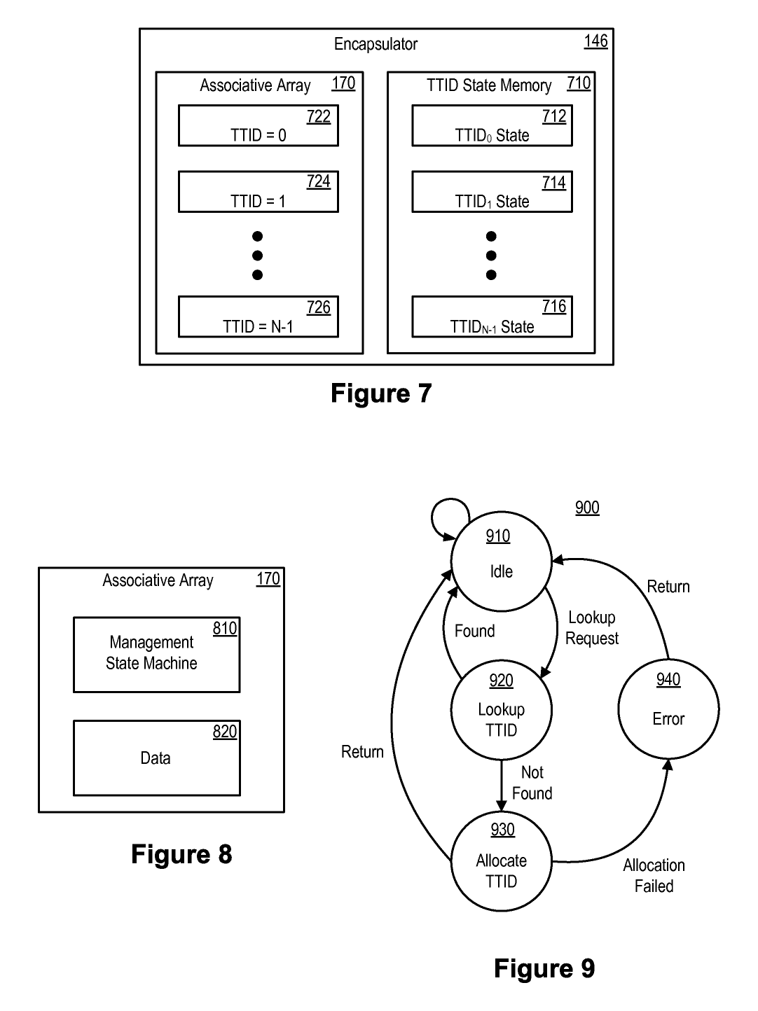

As will be described in more detail with respect to FIGS. 7-17, after the encapsulator 146 receives the split packet request and any associated data, a lookup is performed in the associative array 170 to determine whether the associative array 170 includes an entry for the downstream transaction translator to which the split transaction is addressed. If the associative array 170 includes an entry corresponding to the downstream transaction translator that will receive the split transaction, a secondary scheduler 632 may check the state of that transaction translator as reflected in the state fields 171-173, for example, so that the secondary scheduler 632 can determine in which microframe, for example, to send the split transaction to the downstream transaction translator.

After the secondary scheduler 632 determines that it is time to send the split transaction, the encapsulator 146 passes the split packet request and any associated data to a split transaction root hub 634. The root hub 634 routes the split packet request and any associated data to an appropriate buffer 676 or 678 for an appropriate port (e.g., port 1-4) depending on which port the downstream hub that includes the targeted transaction translator is connected and whether the split transaction is a periodic or asynchronous split transaction. For example, if the split transaction is destined for a full-speed device attached to a high-speed hub and the split transaction includes asynchronous data, the split transaction and any associated data is routed by the root hub 634 into the asynchronous buffer 676. The protocol layer 680 and port manager 682 generate and/or pull the necessary packets from the data stored in the asynchronous buffer 676 for transmission to the hub over the downstream bus at the appropriate time. The protocol layer 680 generates the appropriate split tokens (e.g., start-split or complete-split tokens) and dispatches the tokens on the downstream bus at the appropriate time (e.g., generates the timing between the split token and an OUT token or between the split token and an IN token). The encapsulator 146 passes a wide bus of information that the protocol layer 680 uses to generate the split token. For example, the encapsulator 146 may provide the protocol layer 680 with the hub address, the port number on the hub to which the targeted device is attached, the speed of the transaction, the type of transaction (e.g., a control, interrupt, isochronous, or bulk transaction), the type of start-split packet being issued by the host controller 140 (e.g., a start-split all, start-split begin, start-split mid, or start-split end transaction), and the endpoint type (e.g., control, isochronous, bulk, or control).

After the hub responds (e.g., with a handshake or the data from the targeted device, such as image data from a scanner or input data from a keyboard, for example), the response moves back through the host controller 140 in the reverse direction along a similar path. For example, the response moves from the port manager 682 up through the protocol layer 680, into the asynchronous buffer 676, and eventually onto the bus 128 via the root hub 634, the DMA engine 620, the list processor 618, and the bus interface 612.

As illustrated in FIG. 6, the host controller 140 according to one embodiment includes the primary scheduler 616 and the secondary scheduler 632. When a split transaction is destined for a full-speed or low-speed device attached to a high-speed hub, transactions traverse the bus between the hub and device at a full-speed or low-speed data rate during one millisecond (ms) intervals. Thus, the hub sends scheduled or periodic packets either every one millisecond or some power-of-two multiplier of every one millisecond. The primary scheduler 616 is configured to determine what millisecond interval a split transaction should be executed by a downstream hub and posts the split transaction to the secondary scheduler 632 proceeding the target one-millisecond frame. Between the host controller 140 and the high-speed hub, the framing is 125 microseconds (e.g., the frame rate on the high-speed bus is eight times faster than the frame rate on the low-speed or full-speed bus). The secondary scheduler 632 is configured to break a split transaction (which may take one millisecond to execute) into multiple sub-packets and determine which 125 microsecond frames to transmit those sub-packets. Data stored in the transaction translator state fields 171-173 helps ensure that the targeted downstream transaction translator does not overflow or underflow. According to one embodiment, the schedule is communicated to the host controller 140 by the position in a time domain frame list (i.e., the primary scheduler 616) and further controlled by a set of 8 start-mask and 8 complete-mask bits to control sub-frame split dispatch (i.e., the secondary scheduler 632).

FIG. 7 is a block diagram illustrating additional details of the encapsulator 146 illustrated in FIGS. 1, 2, and 6, according to one embodiment. The encapsulator 146 illustrated in FIG. 7 includes the associative array 170 and a TTID state memory 710, which may be implemented in any suitable machine readable medium, such as registers (flip-flops or latches), RAM, flash memory, and EEPROM. The associative array 170 includes a plurality of transaction translator identifiers (TTIDs) 722-726, each of which has a state field associated therewith. For example, TTID₀ 722 and TTID₀ state field 712 are associated with each other, TTID₁ 724 and TTID₁ state field 714 are associated with each other, and TTID_{N-1} 726 and TTID_{N-1} state field 716 are associated with each other. The state fields 712-716 are configured to store data concerning the state of a downstream transaction translator, such as the number of outstanding transactions and the number of bytes-in-progress to downstream transaction translators (e.g., the number of bytes sent in each frame interval). The number of outstanding transactions may be tracked by transaction type, such as by tracking asynchronous and periodic transactions. Because the state fields 712-716 are associated with a respective TTID 722-726, each transaction translator element ID 722-726 effectively tracks the state of a downstream transaction translator.

The associative array 170 may include any number N of transaction translator element IDs 722-726. According to one embodiment, the transaction translator element IDs 722-726 span the full range of possible transaction translators identified by the number of possible addresses multiplied by the number of possible ports (e.g., N=128*128=16,384). However, fewer transaction translator element IDs 722-726 may be provided. For example, the number of transaction translator element IDs may correspond to the number of devices that the host controller is designed to support (which helps reduce the amount of hardware used to implement the host controller). According to another embodiment, the associative array 170 is provided with 32 transaction translator element IDs 722-726 (i.e., N=32). According to yet another embodiment, the associative array 170 is provided with 64 transaction translator element IDs 722-726 (i.e., N=64).

As will be discussed in more detail with respect to FIGS. 8-17, the TTIDs 722-726 are allocated to downstream transaction translators within high-speed hubs (e.g., high-speed hubs having full-speed or low-speed device attached thereto) that are connected to the host 120 (FIG. 1). If the hub has a single transaction translator that is shared by all of the hub's ports, a single transaction translator element ID may be allocated to the hub. If, on the other hand, the hub includes multiple transaction translators (e.g., a transaction translator for each port), multiple transaction translator element IDs may be allocated to the hub (e.g., one TTID for each transaction translator). According to one embodiment, the associative array 170 is configured such that each TTID 722-726 can be marked unused when there are no active entries and reused at another time by a different transaction translator thereby making the associative array 170 dynamic.

The secondary scheduler 632 (FIG. 6) accesses data stored in state fields 712-716 to help determine when to execute a split transaction. For example, according to one embodiment, the secondary scheduler 632 includes a periodic execution engine and a completion engine, both of which have access (e.g., read/write access) to state fields 712-716. The periodic execution engine is configured to determine in which sub-frames (e.g., microframes) to actually execute the split transaction. After the periodic execution engine fully executes or partially executes the split transaction (e.g., sends a start-split token), the periodic execution engine updates the data stored in one or more of the state fields 712-716 to reflect the state of the downstream transaction translator. After a response from the split transaction is received from the hub, the completion engine is configured to update the data stored in one or more of the state fields 712-716 to reflect the state of the downstream transaction translator. For example, if a start-split transaction occurs and a response comes back from the hub that the start-split transaction was acknowledged, the complete engine updates the state information so that the stored state information moves from a start phase to a complete phase.

FIG. 8 is a block diagram illustrating additional details of the associative array 170 illustrated in FIGS. 1, 2, 6, and 7, according to one embodiment. The associative array 170 illustrated in FIG. 8 includes a management state machine 810 for controlling the operation of the associative array 170 and data 820, such as a set of table entries. Additional details of the management state machine 810 will be described with reference to FIG. 9. According to a preferred embodiment, the data 820 is organized in an array such that a unique key can be used to find its associated value. In other words, the array is indexed by something other than an incrementing numerical index. For example, as shown in Table 1, below, the key used to index the array may comprise transaction translator identifying data, such as the hub address, the hub port, and a multi transaction translator indicator. A lookup performed in the array using the key returns a unique identifier, such as a TTID. The unique identifier maps into the TTID state memory 710, which may include an array of resources, such as state information associated with a downstream transaction translator and the packet collection for each transaction translator. The array in the TTID state memory 710 may comprise a standard array that uses an incrementing numerical index.

Table 1 illustrates an example array into which the data 820 is organized, according to one embodiment. The key used to index the array illustrated in Table 1 comprises a number of fields, including a hub address field that stores the address of the hub containing the target transaction translator, a hub port field that stores the physical port number of the hub port to which the target slow-speed or full-speed device is connected, and a multi transaction translator (multi TT) field that stores an indication of the number of transaction translators that are within the hub (e.g., a “1” may indicate that the hub supports one transaction translator per port and a “0” may indicate that the hub supports one transaction translator that is shared by all ports of the hub). The key may include additional or fewer fields. As shown in Table 1, each key is associated with a TTID. Thus, the hub address, hub port, and multi TT fields can be used to find an associated transaction translator identifier, which has associated therewith state information regarding the transaction translator. The array may also have associated with each TTID a valid indicator that indicates whether a particular TTID is allocated to a transaction translator.

TABLE 1

| | | Key Used To Index Array | | |
|---|---|---|---|---|
| Value | Valid | Hub Address | Hub Port Number | Multi TT |
| TTID = 0 | 1 | 0000101 | 0000001 | 1 |
| TTID = 1 | 1 | 0001010 | 0000010 | 0 |
| TTID = 2 | 0 | — | — | — |
| . | . | . | . | . |
| . | . | . | . | . |
| . | . | . | . | . |
| TTID = N − 1 | 0 | — | — | — |

FIG. 9 is a high-level state transition diagram 900 illustrating example operational states and flow for the management state machine 810 of FIG. 8, according to one embodiment. When the host controller powers up, the management state machine 810 enters an idle state 910. The management state machine 810 remains in the idle state 910 until the encapsulator 146 receives a split packet request (e.g., a split transaction destined for a full-speed or low-speed device attached to a high-speed hub). After receiving a split packet request, the encapsulator 146 (e.g., a tagging module within the encapsulator 146) sends a lookup request to the associative array 170 and the management state machine 810 transitions from the idle state 910 to a lookup state 920.

During the lookup state 920, a lookup operation is performed against the data 820 to retrieve a TTID that has been allocated to the transaction translator for which the split transaction is destined. The lookup operation is performed using as the key information carried with the split packet request. For example, the split packet request may carry with it the address of the hub that contains the target transaction translator, the port number on the hub to which the low-speed or full-speed device is connected, and an indication of whether the hub includes a single transaction translator or multiple transaction translators (e.g., after the hub is connected to the host controller, the hub reports whether it has a single transaction translator or multiple transaction translators). The hub address, hub port, and multi-TT indication are used as the key to retrieve the TTID value that has been allocated to the target transaction translator. If a TTID value is found using the key, the TTID value is returned to the host controller and the management state machine 810 transitions from the lookup state 920 to the idle state 910. The host controller can then use the TTID value to check the state of the transaction translator as reflected by the TTID state field (e.g., state fields 712-716 in FIG. 7) that is associated with the TTID value. If, on the other hand, a TTID value is not found using the key, the management state machine 810 transitions from the lookup state 920 to an allocation state 930.

During the allocation state 930, an unused TTID value is allocated to the target transaction translator. For example, as shown in Table 1, TTID values from 2 to N-1 are not already allocated to another transaction translator as indicated by the valid indicator of “0.” Thus, a TTID value of 2, for example, may be allocated to the target transaction translator. The allocation involves changing the valid indicator for the unused entry (e.g., TTID=2) from “0” to “1” and storing in the appropriate hub address, hub port, and multi-TT fields of the unused entry (e.g., TTID=2) the address of the hub that contains the target transaction translator, the port number on the hub to which the low-speed or full-speed device is connected, and an indication of whether the hub includes a single transaction translator or multiple transaction translators, respectively. After a TTID value has been allocated to the target transaction translator, the allocated TTID value is returned to the host controller and the management state machine 810 transitions from the allocation state 930 to the idle state 910 until the encapsulator 146 receives another split packet request.

If an error occurs during the TTID allocation, the management state machine 810 transitions from the allocation state 930 to an error state 940. For example, if the table is full (e.g., there are no unallocated TTID values) the management state machine 810 transitions to the error state 940 and asserts an error condition. According to one embodiment, the error condition comprises sending an interrupt to the OS with an indication that an error occurred during the allocation attempt. After the error condition is asserted, the OS (or designer) may attempt to debug the error (e.g., if the table is full, the OS may allocate additional memory, such as system memory, for temporary use by the associative array). After asserting the error condition, the management state machine 810 transitions from the error state 940 to the idle state 910.

FIG. 10 is a block diagram illustrating additional details of the state memory 710 of FIG. 7, according to one embodiment. The state memory 710 illustrated in FIG. 10 includes a plurality of state fields 712-716, each of which is associated with a corresponding transaction translator identifier (e.g., TTID 722-726 in FIG. 7). The state fields 712-716 are configured to store data concerning the state of a downstream transaction translator, such as the number of ongoing packets-in-progress (e.g., the number of outstanding transactions with the transaction translator) and the number of bytes-in-progress to downstream transaction translators (e.g., the number of bytes sent in each frame interval). Thus, according to one embodiment, the state memory 710 is indexed by a transaction translator identifier (e.g., TTID 722-726 in FIG. 7) combined with a packet number.

The example state fields 712-716 illustrated in FIG. 10 are configured to track the number of asynchronous and periodic packets that have been sent to the respective transaction translator, the state of those asynchronous and periodic packets, and the amount of data that has been sent to the respective transaction translator (e.g., data that has been sent during each microframe). State fields according to other embodiments may track additional information or less information regarding the state of an associated transaction translator and/or the state of one or more transactions sent to an associated transaction translator.

As discussed with reference to FIG. 7, the associative array 170 may include any number N of transaction translator element IDs 722, 724, and 726, each of which has a corresponding state field 712, 714, and 716 associated therewith. Thus, the state memory 710 may include any number N of state fields 712, 714, and 716. To track the state of a downstream transaction translator, each of the state fields 712, 714, and 716 includes one or more asynchronous packet counters 1010, 1040, and 1070, one or more periodic packet counters 1020, 1050, and 1080, and one or more bytes-in-progress counters 1030, 1060, and 1090.

The one or more asynchronous packet counters 1010, 1040, and 1070 are configured to track the number of asynchronous packets that have been sent to a respective transaction translator. According to one embodiment, the asynchronous packet counters 1010, 1040, and 1070 comprise sequence packet counters configured to count to a maximum number M. According to one embodiment, M is set to two, which is the maximum number of asynchronous packets that can generally be sent to a transaction translator (e.g., based on the number of non-periodic buffers included in the transaction translators in the downstream hub). According to other embodiments, M may be less than or greater than two (e.g., if the host controller determines that the non-periodic buffer(s) within a downstream transaction translator can accommodate more than two transactions or fewer than two transactions, the asynchronous packet counters may be adjusted accordingly).

The asynchronous packet counters 1010, 1040, and 1070 may include pointers 1011, 1041, and 1071, which point to the last packet that was posted to a respective asynchronous packet list 1012, 1042, or 1072. Each of the asynchronous packet lists 1012, 1042, and 1072 include M memory locations or slots (e.g., two or any other number as discussed above) that store for each packet header information (e.g., information in the IN or OUT token that follows a start-split token, such as the target device and endpoint addresses) and state information (e.g., whether the packet has been sent to the downstream transaction translator or whether the hub has received an acknowledgment from the hub that the packet has been sent to the downstream low-speed or full-speed device). The packet lists 1012, 1042, and 1072 may also include valid bits or flags 1014, 1016, 1044, 1046, 1074, and 1076 that indicate whether an associated memory location is occupied.

Each time an asynchronous packet is to be dispatched to a downstream transaction translator, the appropriate asynchronous packet counter is incremented, header and state information associated with that packet are stored in the next available memory location in the packet list, and the valid bit associated with that memory location is updated. For example, as illustrated in FIG. 10, the pointer 1011 is pointing to the memory location 1015 in the packet list 1012, which indicates that two asynchronous packets have been dispatched to the transaction translator associated with the state memory 712. Thus, valid bits 1014 and 1016 in the packet list 1012 are set to indicate that each of memory locations 1013 and 1015 are occupied and store header and state information associated with an asynchronous packet. Similarly, the pointer 1071 is pointing to the memory location 1075 in the packet list 1072, which indicates that two asynchronous packets have been dispatched to the transaction translator associated with the state memory 716. Thus, valid bits 1074 and 1076 in the packet list 1072 are set to indicate that each of memory locations 1073 and 1075 are occupied and store header and state information associated with an asynchronous packet. The pointer 1041, on the other hand, is pointing to the memory location 1043 in the packet list 1042, which indicates that only one asynchronous packet has been dispatched to the transaction translator associated with the state memory 714. Thus, the valid bit 1044 is set to indicate that the memory locations 1043 is occupied and stores header and state information associated with an asynchronous packet and valid bit 1046 is set to indicated that the memory location 1045 is unoccupied and does not store header and state information associated with an asynchronous packet.

If an asynchronous packet counter indicates that two asynchronous packets are already in progress (e.g., the pointer points to the last memory location in the packet list), additional asynchronous packets will not be dispatched until at least one of the pending asynchronous packets have completed execution. Accordingly, if the host controller receives another asynchronous transaction request that is destined for one of the transaction translators associated with the state memories 712, 714, and 716, a scheduler (e.g., the primary scheduler 616 or secondary scheduler 632 in FIG. 6) can check an appropriate asynchronous packet counter to determine whether the new transaction can be dispatched or whether the new transaction should be delayed until one of the pending asynchronous packets has completed execution. For example, after checking asynchronous packet counters 1010 and 1070 (which indicate that two asynchronous packets are already in progress with the transaction translators associated with state memories 712 or 716), the host controller will not dispatch any new asynchronous transactions to those transaction translators until at least one of the pending asynchronous packets has completed execution. On the other hand, after checking the asynchronous packet counter 1040 (which indicates that only one asynchronous packet is already in progress with the transaction translator associated with the state memory 714), the host controller can dispatch a new asynchronous transactions to that transaction translator.

One or more periodic packet counters 1020, 1050, and 1080 are configured to track the number of periodic packets that have been sent to a respective transaction translator in a given one-millisecond frame. According to one embodiment, the periodic packet counters 1020, 1050, and 1080 comprise sequence packet counters configured to count to a maximum number Y. According to one embodiment, Y is set to sixteen, which is the maximum number of periodic packets that can generally be sent to a transaction translator in a given one-millisecond frame. It may be possible to send more than sixteen periodic packets in a given one-millisecond frame if, for example, a complete-split clears one of the token entries before a start-split is sent and a memory location within a packet list is re-occupied. In other words, according to one embodiment, a periodic frame list supports more than sixteen periodic packets but no more than sixteen periodic packets are pending at a given time. According to another embodiment, Y is set to fifteen, which may be easier to implement in memory if the state memory tracks two asynchronous packet states and two sets of fifteen periodic packet states for a total of thirty-two packet states. Providing two or more sets of fifteen periodic packet states in state memories 712-716 (e.g., even and odd packet lists) allows periodic packets in two consecutive one-millisecond frames to be tracked, which helps manage scheduling overlaps. If two or more sets of fifteen periodic packet states are provided in state memories 712-716, a corresponding number of periodic packet counters may also be provided. According to still another embodiment, the number of packets is not fixed per transaction translator identifier and instead is dynamically allocated to each transaction translator identifier from a global pool. Thus, Y may be dynamically allocated to each transaction translator identifier. Dynamically allocating the number of packets to each transaction translator identifier may be particularly well suited for a firmware implementation.

The periodic packet counters 1020, 1050, and 1080 may include pointers 1021, 1051, and 1081, which point to the last packet that was posted to a respective periodic packet list 1022, 1052, or 1082. Each of the periodic packet lists 1022, 1052, and 1082 include a total of Y memory locations or slots (e.g., fifteen, sixteen, or any other number) that store for each packet header information (e.g., information in the IN or OUT token that follows a start-split token, such as the target device and endpoint addresses) and state information (e.g., whether the packet has been sent to the downstream transaction translator or whether the hub has received an acknowledgment from the hub that the packet has been sent to the downstream low-speed or full-speed device). The packet lists 1022, 1052, and 1082 may also include valid bits or flags 1024-1028, 1054-1058, and 1084-1088 that indicate whether an associated memory location is occupied.

Each time a periodic packet is dispatched to a downstream transaction translator, the appropriate periodic packet counter is incremented, header and state information associated with that packet are stored in the next available memory location in the packet list, and the valid bit associated with that memory location is updated. For example, as illustrated in FIG. 10, the pointer 1021 is pointing to the memory location 1025 in the packet list 1022, which indicates that two periodic packets are scheduled to be dispatched to the transaction translator associated with the state memory 712. Thus, valid bits 1024 and 1026 in the packet list 1022 are set to indicate that each of the memory locations 1023 and 1025 are occupied and store header and state information associated with a periodic packet. Valid bits after valid bit 1026 and up to valid bit 1028 are set to indicate that corresponding memory locations are unoccupied and do not store header and state information associated with a periodic packet. The pointer 1051 is pointing to memory location 1057 in the packet list 1052, which indicates that Y periodic packets are scheduled to be dispatched to the transaction translator associated with the state memory 714 (i.e., the packet list 1052 is full). Thus, valid bits 1054 through 1058 in the packet list 1052 are set to indicate that each of the memory locations 1053 through 1057 are occupied and store header and state information associated with a periodic packet. The pointer 1081 is pointing to the memory location 1083 in the packet list 1082, which indicates that only one periodic packet is scheduled to be dispatched to the transaction translator associated with the state memory 716. Thus, only valid bit 1084 in the packet list 1082 is set to indicate that the memory location 1083 is occupied and stores header and state information associated with a periodic packet. Valid bits after 1084 and up to valid bit 1088 are set to indicate that corresponding memory locations are unoccupied and do not store header and state information associated with a periodic packet.

If a periodic packet counter indicates that the maximum number Y of periodic packets has been reached (e.g., the pointer points to the last memory location in the packet list), additional periodic packets will not be added to the packet list until at least one of the pending periodic packets has completed execution. Accordingly, if the host controller receives another periodic transaction request destined for one of the transaction translators associated with the state memories 712, 714, and 716, a scheduler (e.g., the primary scheduler 616 or secondary scheduler 632 in FIG. 6) can check an appropriate periodic packet counter to determine whether the new transaction can be scheduled for dispatch or whether the new transaction should be delayed until one of the pending periodic packets has completed execution. For example, after checking the periodic packet counter 1050 (which indicates that the maximum number Y of periodic packets are already in progress with the transaction translator associated with the state memory 714), the host controller will not add any new periodic transactions to the packet list 1052 until at least one of the pending periodic packets has completed execution. On the other hand, after checking the periodic packet counters 1020 and 1080 (which indicate that fewer than the maximum number Y of periodic packets are scheduled for dispatch to the transaction translators associated with the state memories 712 and 716), the host controller can add new periodic transactions to packet lists 1022 and 1082.

The one or more bytes-in-progress counters 1030, 1060, and 1090 are configured to track the amount of data that has been or will be transmitted to a respective transaction translator. According to one embodiment, the host controller utilizes the counters 1030, 1060, and 1090 to throttle the rate at which start-split transactions are dispatched, which may, for example, help prevent an overflow of the periodic buffers within a downstream transaction translator.

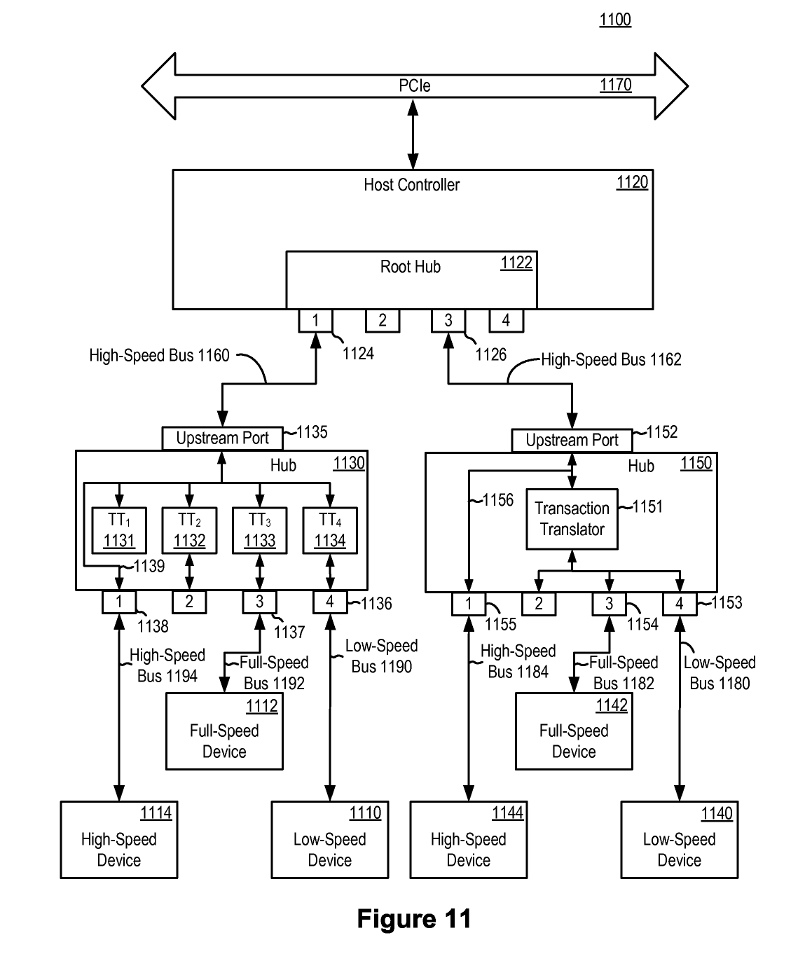

FIG. 11 is a block diagram illustrating a system 1100 in which a low-speed device 1110, a full-speed device 1112, and a high-speed device 1114 are attached to a host 1120 via an intermediate high-speed hub 1130 incorporating multiple transaction translators 1131-1134 and in which a low-speed device 1140, a full-speed device 1142, and a high-speed device 1144 are attached to the host 1120 via an intermediate high-speed hub 1150 incorporating a single transaction translator 1151, according to one embodiment. An upstream port 1135 of the hub 1130 is connected to port 1 (1124) of root hub 1122 via a high-speed bus 1160. An upstream port 1152 of the hub 1150 is connected to port 3 (1126) of the root hub 1122 via a high-speed bus 1162. The host controller 1120 is similar or identical to the host controller 140 illustrated in FIGS. 1, 2, and 6. The host controller 1120 communicates with other components of the host (e.g., the host 120 in FIG. 1), such as a processor and a memory, via a bus 1170, such as a PCIe bus.

A low-speed bus 1180 (e.g., having a USB low-speed data transfer rate of approximately 1.5 megabits per second) couples the low-speed device 1140 to port 4 (1153) of the hub 1150. A full-speed bus 1182 (e.g., having a USB full-speed data transfer rate of approximately 12 megabits per second) couples the full-speed device 1142 to port 3 (1154) of the hub 1150. The low-speed and full-speed devices 1140 and 1142 share the transaction translator 1151, which converts high-speed split transactions to low-speed transactions for the low-speed device 1140 and converts high-speed split transactions to full-speed transactions for the full-speed device 1142, so that data can be transferred between the host controller 1120 and the hub 1150 at high-speed (e.g., a USB high-speed data transfer rate of approximately 480 megabits per second). A high-speed bus 1184 (e.g., having a USB high-speed data transfer rate of approximately 480 megabits per second) couples the high-speed device 1144 to port 1 (1155) of the hub 1150. Because high-speed buses 1162 and 1184 operate at the same or similar speeds, the transaction translator 1151 is not needed to perform a speed translation. Thus, the hub 1150 routes data between the upstream port 1152 and port 1 (1155) via path 1156, which bypasses the transaction translator 1151.

In a similar vein, a low-speed bus 1190 (e.g., having a USB low-speed data transfer rate of approximately 1.5 megabits per second) couples the low-speed device 1110 to port 4 (1136) of the hub 1130. A full-speed bus 1192 (e.g., having a USB full-speed data transfer rate of approximately 12 megabits per second) couples the full-speed device 1112 to port 3 (1137) of the hub 1130. The hub 1130 routes data communication between the host controller 1120 and the low-speed device 1110 through the transaction translator 1134, which converts high-speed split transactions to low-speed transactions (and vice versa) so that data can be transferred between the host controller 1120 and the hub 1130 at high-speed. Similarly, the hub 1130 routes data communication between the host controller 1120 and the full-speed device 1112 through the transaction translator 1133, which converts high-speed split transactions to full-speed transactions (and vice versa) so that data can be transferred between the host controller 1120 and the hub 1130 at high-speed. A high-speed bus 1194 (e.g., having a USB high-speed data transfer rate of approximately 480 megabits per second) couples the high-speed device 1114 to port 1 (1138) of the hub 1130. Because high-speed buses 1160 and 1194 operate at the same or similar speeds, the transaction translator 1131 is not needed to perform a speed translation. Thus, the hub 1130 routes data between the upstream port 1135 and port 1 (1138) via path 1139, which bypasses the transaction translator 1131.

Table 2 below illustrates example entries in an associative array used to track the transaction translators of FIG. 11, according to one embodiment. Table 2 assumes that the host 120 (e.g., via the OS) assigned a hub address of 1 to the hub 1130, a hub address of 2 to the hub 1150, a device address of 3 to the high-speed device 1114, a device address of 4 to the full-speed device 1112, a device address of 5 to the low-speed device 1110, a device address of 6 to the high-speed device 1144, a device address of 7 to the full-speed device 1142, and a device address of 8 to the low-speed device 1140. The host 120 generally assigns addresses from the top down and then from left to right with respect to incrementing ports.

TABLE 2

| | | Key Used To Index Array | | |
|---|---|---|---|---|
| Value | Valid | Hub Address | Hub Port Number | Multi TT |
| TTID = 0 | 1 | 0000001 (1) | 0000011 (3) | 1 |
| TTID = 1 | 1 | 0000001 (1) | 0000100 (4) | 1 |
| TTID = 2 | 1 | 0000010 (2) | X | 0 |
| TTID = 3 | 0 | — | — | — |
| . | . | . | . | . |
| . | . | . | . | . |
| . | . | . | . | . |
| TTID = N − 1 | 0 | — | — | — |

As illustrated in Table 2, TTID₀ is allocated to the transaction translator 1133, TTID₁ is allocated to the transaction translator 1134, and TTID₂ is allocated to the transaction translator 1151. The transaction translator 1151 is shared by the low-speed and full-speed devices 1140 and 1142, so the corresponding hub port number in Table 2 is marked with an “X” (representing a don't-care condition). Each time the host controller 1120 communicates with a low-speed or full-speed device connected to hubs 1130 or 1150 (e.g., for each split packet request), a lookup is performed against the associative array (Table 2) using information fields carried with the split packet request (e.g., the address of the hub that contains the target transaction translator, the port number on the hub to which the low-speed or full-speed device is connected, and an indication of whether the hub includes a single transaction translator or multiple transaction translators). If the lookup fails because there is no match against any of the entries in the table, any unused entry can be written by the allocation state (e.g., allocation state 930 in FIG. 9). If a match is found (or after a TTID is allocated), the associative array (Table 2) returns the TTID value that has been allocated to the target transaction translator. The returned TTID value maps into a state memory (e.g., the TTID state memory 710 in FIG. 7), which includes an array of resources, such as state information associated with a target transaction translator and the packet collection for that transaction translator.

For example, if the host controller receives a request to send data to the low-speed device 1110 (an OUT transaction), a lookup is performed against the associative array (Table 2) using a hub address of 1, a port number of 4, and a multi-TT indicator of 1, all of which are carried with the split packet request. The associative array (Table 2) will return a TTID value of 1 (TTID₁), which has been allocated to the target transaction translator 1134. The state memory associated with TTID₁ can then be updated so a split transaction (e.g., a start-split) for the split packet request can be added to a packet list for dispatch to the hub 1130.

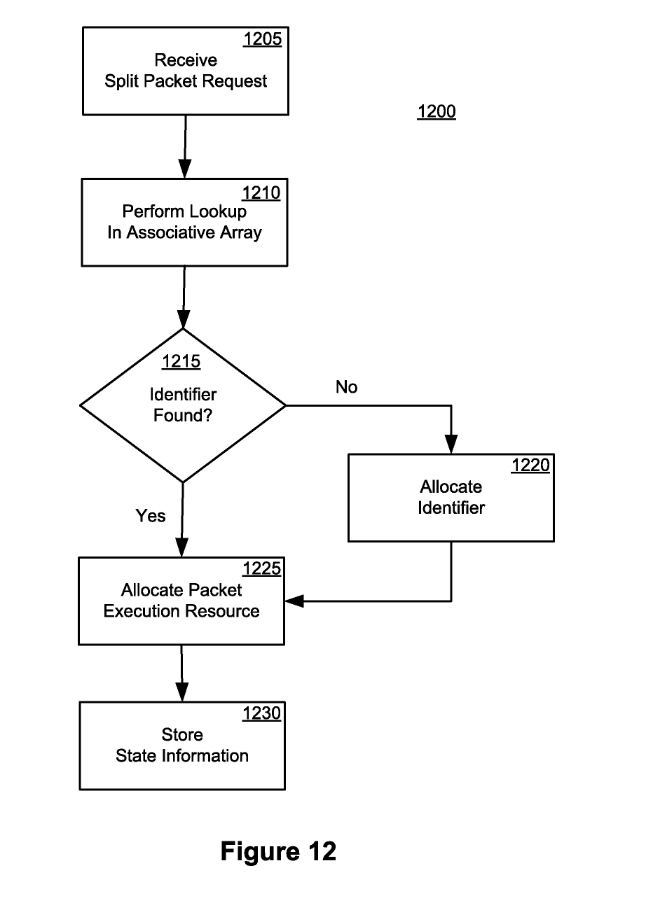

FIG. 12 illustrates a flow chart of a method 1200 for updating state information associated with a transaction translator within a downstream hub, according to one embodiment. System software, such as the OS, device drivers, or client drivers, initiates transfer to or from a target device by issuing transaction requests to the host engine. For example, a keyboard driver may poll a low-speed or full-speed keyboard (e.g., to check if a key has been depressed) by generating a split packet request and supplying a memory buffer into which any keyboard data should be stored. The system software may issue a transaction request by generating one or more transfer request block rings and ringing a doorbell. After the system software sets up the transfer request block rings and rings the doorbell, the primary scheduler 616 (FIG. 6) initiates a transaction request by sending a request to the list processor 618 to service the endpoint. If the list processor 618 determines that the transaction request involves a split transaction destined for a full-speed or low-speed device attached to a hub operating at high-speed, the list processor 618 executes the split transaction by generating a split packet request (e.g., from state and/or data information fields stored in a control memory associated with the list processor 618) and handing the split packet request off to the DMA engine 620, which pairs the split packet request up with the necessary data movement and passes the split packet request and any associated data to the encapsulator 146.

At step 1205, a split packet request is received (e.g., the encapsulator 146 receives or accesses a split packet request that was generated by the list processor 618). The split packet request includes information the host controller uses to communicate with the target device, such as the device address, endpoint address, endpoint direction (e.g., IN or OUT), byte count, hub address, hub port number, and an indication of whether the hub to which the target device is attached includes a single transaction translator or multiple transaction translators. One or more of the encapsulator 146, the tagging module 1560, or the identifier tagging module 1320 may be configured to receive the split packet request as illustrated in FIG. 15.

After receiving the split packet request, the encapsulator performs a lookup (step 1210) in an associative array to retrieve an identifier (e.g., TTID) associated with a downstream transaction translator or other speed translation component that handles the conversion of high-speed packets to low-speed or full-speed packets destined for the target low-speed or full-speed device. According to a preferred embodiment, a lookup is performed at step 1210 using at least a portion of the information included in the split packet request, such as the address of the hub that contains the transaction translator, the port number on the hub to which the target low-speed or full-speed device is connected, and an indication of whether the hub includes a single transaction translator or multiple transaction translators (e.g., a multi-TT indicator). According to other embodiments, a lookup is performed at step 1210 using different information (e.g., information in addition to the hub address, hub port number, and multi-TT indicator or information other than the hub address, hub port number, and multi-TT indicator), which may be carried with the split packet request, sent to the host controller in a separate transaction, accessed by the host controller (e.g., in a shared memory), or generated by the host controller. One or more of the associative array 170, the management state machine 810, the lookup logic 1330, the tagging module 1560, or the identifier tagging module 1320 may be configured to perform a lookup in an associative array as illustrated in FIGS. 9, 13, 14, and 15. Additional details regarding performing a lookup in an associative array are described with reference to FIGS. 9, 13 and 14.

If an identifier associated with the downstream transaction translator is found (step 1215), the method 1200 proceeds to step 1225. If, on the other hand, an identifier associated with the downstream transaction translator is not found (step 1215), the method 1200 proceeds to step 1220 and an identifier is allocated to the transaction translator. Additional details regarding allocating an identifier to a transaction translator or other speed translation component that handles the conversion of high-speed packets to low-speed or full-speed packets destined for the target low-speed or full-speed device are described with reference to FIG. 9.

After an identifier associated with the downstream transaction translator to which the split packet request relates has been found in the associative array (or is allocated at step 1220), a packet execution resource (e.g., a packet number, packet pointer, resource handle, or other resource identifier) is allocated at step 1225 to a transaction (e.g., an IN or OUT low-speed or full-speed transaction) associated with the split packet request. For each downstream transaction translator, a specific number of ongoing packets-in-progress are reserved per identifier instance (e.g., TTID instance). For example, due to system resource constraints (e.g., bus bandwidth and transaction translator buffer size) only a finite number of transactions (e.g., low-speed or full-speed transactions) are dispatched to a downstream transaction translator. According to a preferred embodiment, the number of packets-in-progress that are reserved per instance is set to satisfy the split-transaction scheduling requirements for transaction translators specified in the Universal Serial Bus Specification Revision 2.0, dated Apr. 27, 2000. For example, the number of periodic packets-in-progress that are reserved per instance may be set to not exceed 16 periodic packets-in-progress and the number of asynchronous packets-in-progress that are reserved per instance may be set to not exceed 2 asynchronous packets-in-progress. Additional or fewer packets-in-progress may be reserved per instance. If, for example, full host capability is not needed, fewer packets-in-progress may be reserved per instance.

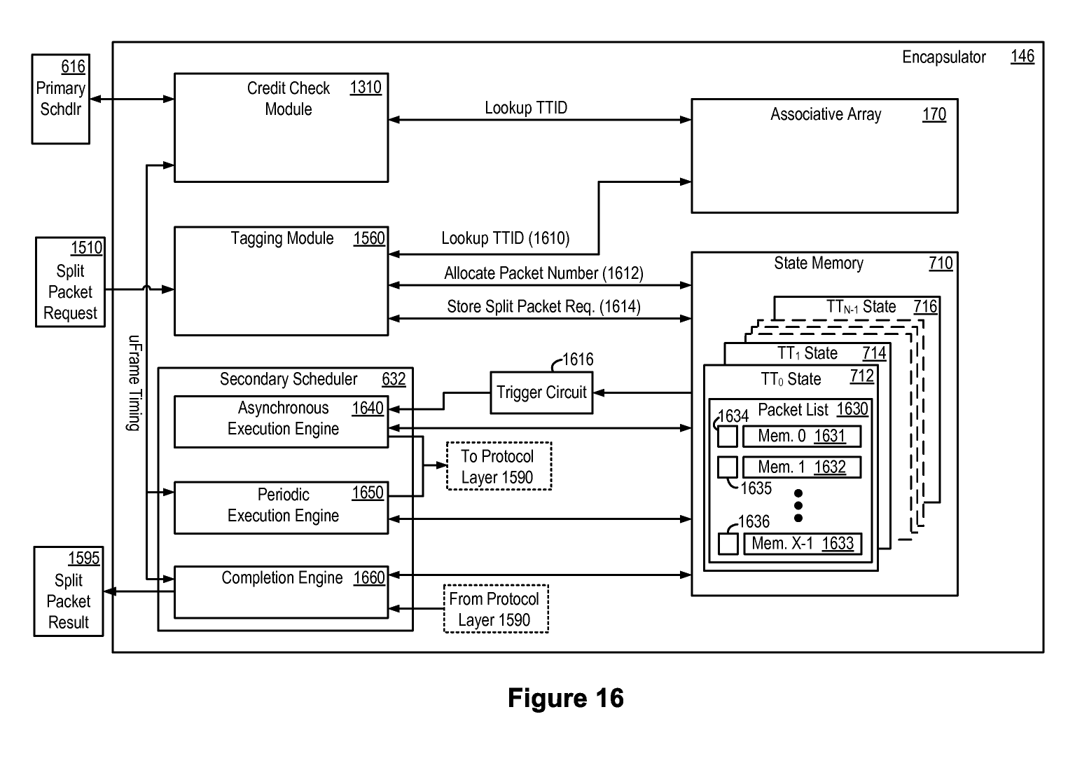

By way of example, if two asynchronous packets and sixteen periodic packets can be dispatched to a downstream transaction translator, two asynchronous packet execution resources and sixteen periodic packet execution resources are reserved per transaction translator. With reference to FIGS. 10 and 12, after an identifier associated with the downstream transaction translator to which the split packet request relates has been found in the associative array (or is allocated at step 1220), one of the asynchronous or periodic packet execution resources is allocated at step 1225 to the transaction associated with the split packet request. For example, if one asynchronous packet is already reserved for dispatch (e.g., asynchronous packet number 0 is allocated to another transaction), asynchronous packet number 1 is allocated at step 1225 to the asynchronous transaction associated with the current split packet request. By way of another example, if five periodic packets have already been scheduled for dispatch during an upcoming one-millisecond frame (e.g., one of the pointers 1021, 1051, and 1081 in FIG. 10 points to the memory location associated with periodic packet number 4), the memory location associated with the periodic packet number 5 is allocated at step 1225 to the periodic transaction associated with the current split packet request. One or more of the tagging module 1560 or the transaction number tagging module 1570 may be configured to allocate a packet execution resource as illustrated in FIGS. 15 and 16.

At step 1230, state information associated with the split packet request is stored or updated. The state information may include general state information, packet state information, or both general and packet state information. Storing or updating the general state information includes, for example, incrementing a packet counter (e.g., the asynchronous packet counters 1010, 1040, or 1070 or the periodic packet counters 1020, 1050, and 1080 in FIG. 10) and adding the number of bytes associated with the transaction to a bytes-in-progress counter (e.g., counters 1030, 1060, or 1090 in FIG. 10). Storing or updating the packet state information includes, for example, storing in a state memory packet information, such as the device address, endpoint address, endpoint direction (e.g., IN or OUT), byte count, hub address, hub port number, and single or multiple transaction translator indicator, and packet state information, such as the packet phase (e.g., start-split or complete-split), isochronous OUT packet phase (e.g., start-split all, begin, mid, or end as indicated in the S&E fields), and fraction of packet length remaining to be transferred. One or more of the tagging module 1560 or the transaction number tagging module 1570 may be configured to store state information associated with the split packet request as illustrated in FIGS. 15 and 16.

With reference to FIGS. 10 and 12, each time an asynchronous packet is to be dispatched to a downstream transaction translator, the appropriate asynchronous packet counter (e.g., counter 1010, 1040, or 1070) is incremented and header and state information associated with that packet are stored in the next available memory location in the packet list (e.g., memory locations 1013 or 1015 in packet list 1012). Similarly, each time an periodic packet is scheduled to be dispatched to a downstream transaction translator, the appropriate periodic packet counter (e.g., counter 1020, 1050, or 1080) is incremented and header and state information associated with that periodic packet are stored in the next available memory location in the packet list (e.g., memory locations 1023 through 1027 in packet list 1022). In other words, at step 1230, state information is updated and another packet is added to a list of packets to be dispatched during an upcoming one millisecond frame.

According to one embodiment, the identifier associated with the downstream transaction translator (e.g., the TTID) and the packet execution resource associated with the transaction (e.g., the packet number) form the address in the state memory (e.g., the state memory is indexed by the identifier and the packet execution resource). Thus, steps 1210 through 1225 of the method 1200 help determine where to store the state information associated with the split packet request.

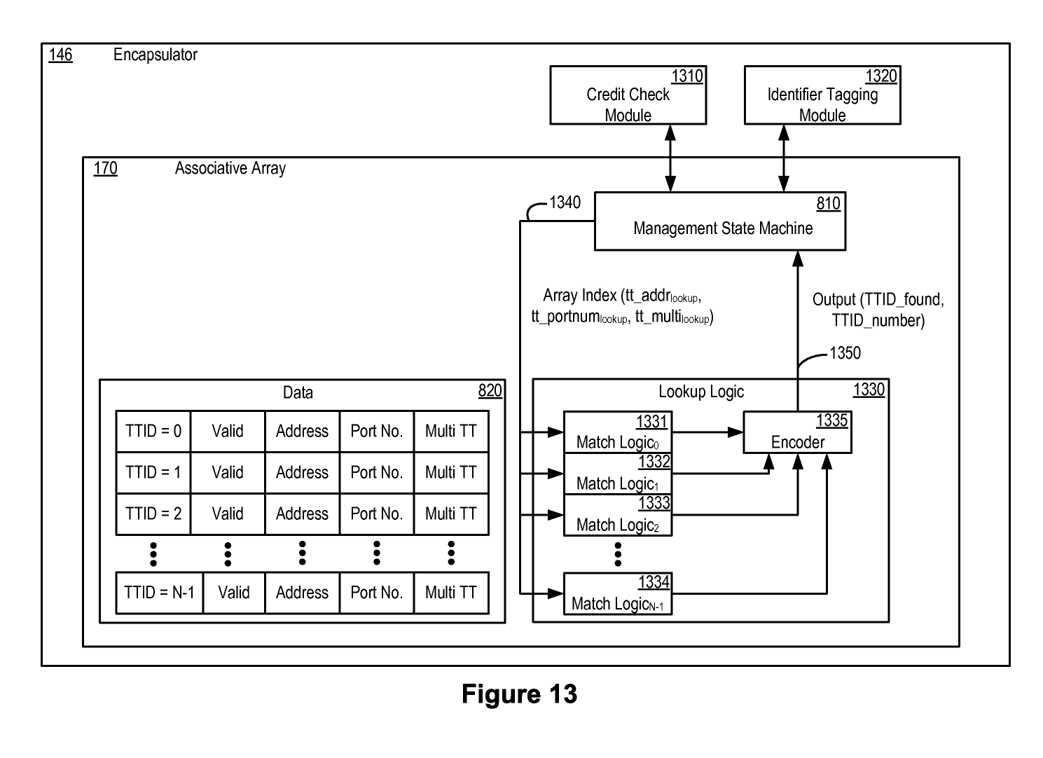

FIG. 13 is a block diagram illustrating two modules 1310 and 1320 that perform lookups in the associative array 170 and lookup logic 1330 used to perform the lookups, according to one embodiment. The encapsulator 146 may include one or more agents or modules that access the associative array 170 to determine an identifier associated with a downstream transaction translator (e.g., a TTID). For example, the encapsulator 146 illustrated in FIG. 13 includes a credit check module or agent 1310 and an identifier tagging module or agent 1320. The credit check module 1310 may, for example, be used by the primary scheduler 616 (FIG. 6) to determine whether there is at least one available memory location in an appropriate packet list (e.g., memory locations 1023 through 1027 in packet list 1022 of FIG. 10). The identifier tagging module 1320 is configured to tag a split packet request with an identifier associated with a downstream transaction translator, which is described in more detail with respect to FIG. 15.

After encapsulator 146 receives or accesses a split packet request, one or more of the modules 1310 and 1320 issues a lookup request to the management state machine 810. The lookup request may include information from the split packet request, such as the address of the hub that contains the transaction translator, the port number on the hub to which the target low-speed or full-speed device is connected, and a single or multiple transaction translator indicator (e.g., a multi-TT indicator). After receiving the lookup request, the management state machine 810 performs a lookup (and possible allocation) as described with reference to FIGS. 9 and 12 and returns to the appropriate module 1310 or 1320 the identifier associated with the target downstream transaction translator (e.g., TTID).

As described with reference to FIG. 8, the data 820 includes a plurality of unique identifiers (e.g., TTIDs). Each of the unique identifiers has associated with it a number of fields, including a valid field that indicates whether the identifier has been allocated to a transaction translator, a hub address field that stores the address of the hub containing the target transaction translator, a hub port field that stores the physical port number of the hub port to which the target slow-speed or full-speed device is connected, and a multi transaction translator (multi TT) field that stores an indication of the number of transaction translators that are within the hub (e.g., a “1” may indicate that the hub supports one transaction translator per port and a “0” may indicate that the hub supports one transaction translator that is shared by all ports of the hub). The valid indicator provides a convenient mechanism to reclaim identifiers when the identifiers are not in use. For example, the valid indicator can be cleared when a particular identifier is not being used to track the state of a downstream transaction translator. In certain embodiments, the valid field is not provided.

The lookup logic 1330 includes match logic 1331 through 1334, each of which is associated with a unique identifier (e.g., TTID) or entry included in the data 820. In other words, match logic₀ (1331) is associated with TTID₀, match logic₁ (1332) is associated with TTID₁, match logic₂ (1333) is associated with TTID₂, and match logic_{N-1} (1333) is associated with TTID_{N-1}. An encoder 1335 is provided to report whether an identifier was found during the lookup and report the identifier number that was found, if any.

The management state machine 810 performs a lookup or indexes the data 820 using a unique key that includes transaction translator identifying data, such as the hub address, the hub port number, and a multi transaction translator indicator. The unique key (e.g., tt_addrₗₒₒₖᵤₚ, tt_portnumₗₒₒₖᵤₚ, and tt_multiₗₒₒₖᵤₚ) is provided to each of the match logic blocks 1331 through 1334 via a match logic input 1340 (e.g., a 15-bit bus). The output of each of the match logic blocks 1331 through 1334 is supplied to the encoder 1335, which consolidates the results from the match logic blocks 1331 through 1334 into a single encoder output 1350. Only one of the match logic blocks 1331 through 1334 should return a match (e.g., with a logic “1”). The encoder output 1350 (e.g., a 6-bit bus to transfer, for example, a 5-bit encoded number for 32 TTIDs plus a 1-bit TTID found indicator) is connected to the management state machine 810 and outputs an indication of whether an identifier was found during the lookup and the particular identifier found, if any (e.g., TTID_found and TTID_number). The management state machine 810 returns to the appropriate module 1310 or 1320 the particular identifier found (or that was allocated).

Equation 1 illustrates a Boolean equation that implements a single instance of the match logic 1331 through 1334, according to one embodiment.

$${Match}_{i} = {valid}_{i} AND \\ ( {tt}_{{addr}_{i}} = {tt}_{{addr}_{lookup}} ) AND \\ ( \begin{matrix}( {tt}_{{portnum}_{i}} = {tt}_{{portnum}_{lookup}} ) OR \\ ( NOT {tt\_mult}_{i} AND NOT {tt\_multi}_{lookup} )\end{matrix} ) \qquad ( Equation 1 )$$

In Equation 1, i corresponds to the identifier, which has a value ranging from 0 to N-1, N corresponds to a maximum number of identifiers stored in the associative array 170, validᵢ is 0 if the identifier is not allocated to a transaction translator or 1 if the identifier is allocated to a transaction translator, tt_addrᵢ is the hub address mapped to the corresponding identifier, tt_portnumᵢ is the hub port number mapped to the corresponding identifier, tt_multiᵢ is 0 if the downstream hub supports one transaction translator or 1 if the downstream hub supports more than one transaction translator, tt_addrₗₒₒₖᵤₚ, tt_portnumₗₒₒₖᵤₚ, and tt_multiₗₒₒₖᵤₚ correspond to the hub address value, the hub port number, and the multi transaction translator indicator included in the split packet request, and Matchᵢ returns 0 if the hub address value, the hub port number, and the multi transaction translator indicator are not mapped to an identifier or 1 if the hub address value, the hub port number, and the multi transaction translator indicator are mapped to an identifier.

In Equation 1, the expression (NOT tt_multᵢ AND NOT tt_multiₗₒₒₖᵤₚ) helps ensure that a new identifier (e.g., TTID) is allocated to a downstream transaction translator unless the multi transaction translator indicators included in the split packet request and stored the associative array 170 are zero. For example, if two low-speed or full-speed devices are attached to a hub that includes a single transaction translator, the OS or device driver may erroneously set the multi transaction translator context field to “0” for one device and “1” for the other device, which may create inconsistencies during lookups and/or identifier allocations. In other words, if the OS or driver sends a transaction request that indicates that the target hub includes multiple transaction translators but a previous transaction request indicated that the same target hub includes a single transaction translator, an inconsistency arises, which is handled by allocating a new identifier to the target hub through the use of the expression (NOT tt_multᵢ AND NOT tt_multiₗₒₒₖᵤₚ) in Equation 1.

According to other embodiments, the match logic 1331 through 1334 is implemented using other suitable equations. For example, according to one embodiment, the expression (NOT tt_multᵢ AND NOT tt_multiₗₒₒₖᵤₚ) in Equation 1 is replaced by the expression (NOT tt_multᵢ AND tt_multiₗₒₒₖᵤₚ). According to another embodiment, the expression (NOT tt_multᵢ AND NOT tt_multiₗₒₒₖᵤₚ) in Equation 1 is replaced by the expression (tt_multᵢ AND NOT tt_multiₗₒₒₖᵤₚ).

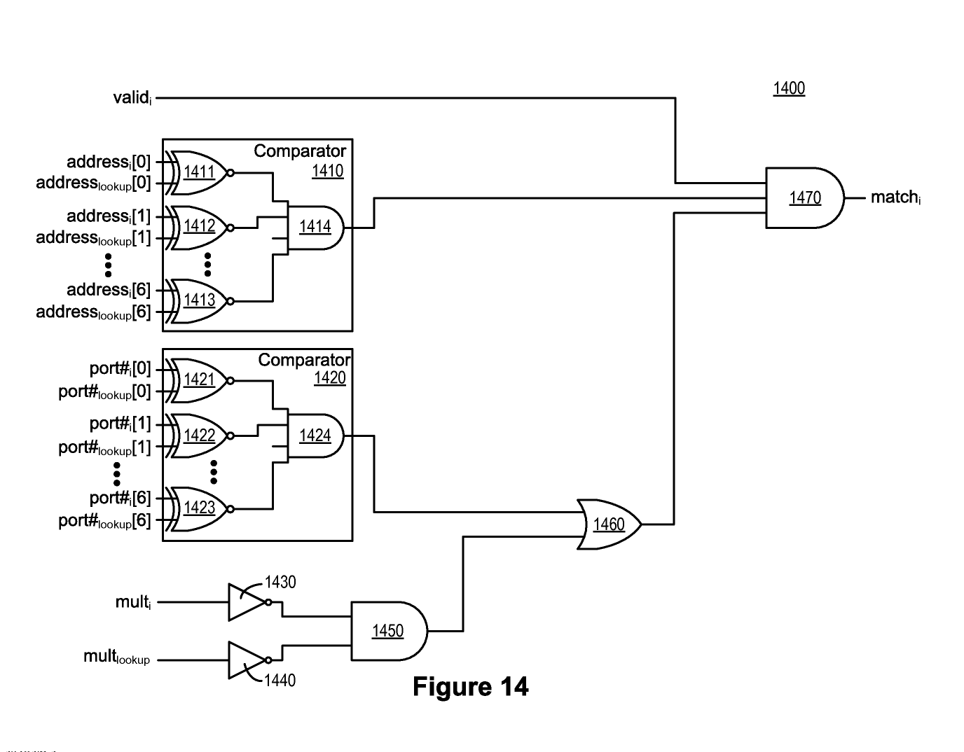

FIG. 14 is a logic diagram of a match logic circuit 1400, according to one embodiment. The match logic circuit 1400 represents one instance of the match logic 1331 through 1334 of FIG. 13. The match logic circuit 1400 is preferably implemented in hardware, but may be implemented in any combination of hardware, firmware, or software.

The match logic circuit 1400 includes two comparators 1410 and 1420 that test the equality of two values (e.g., two 7-bit numbers) by performing a bit-by-bit comparison of the values. The comparator 1410 performs a bit-by-bit comparison of (1) the hub address provided with the lookup request (e.g., the hub address included in the split packet request) and (2) the hub address stored the associative array 170 (e.g., the hub address associated with the particular identifier being tested). The comparator 1410 returns a logical “1” if the two hub addresses are equal or returns a logical “0” if the two hub addresses are not equal. The comparator 1410 includes a plurality of XNOR gates 1411 through 1413, the outputs of which are coupled to an AND gate 1414. The first bits of the lookup and stored hub addresses are provided to XNOR gate 1411, the second bits of the lookup and stored hub addresses are provided to XNOR gate 1412, and so forth.

In a similar vein, the comparator 1420 performs a bit-by-bit comparison of (1) the hub port number provided with the lookup request (e.g., the hub port number included in the split packet request) and (2) the hub port number stored the associative array 170 (e.g., the hub port number associated with the particular identifier being tested). The comparator 1420 returns a logical “1” if the two hub port numbers are equal or returns a logical “0” if the two hub port numbers are not equal to each other. The comparator 1420 includes a plurality of XNOR gates 1421 through 1423, the outputs of which are coupled to an AND gate 1424. The first bits of the lookup and stored hub port numbers are provided to XNOR gate 1421, the second bits of the lookup and stored hub port numbers are provided to XNOR gate 1422, and so forth. While the comparators 1410 and 1420 are illustrated as 7-bit comparators, the comparators 1410 and 1420 may compare more than 7 bits at a time or less than 7 bits at a time (e.g., if the hub address or hub port number are greater or less than 7 bits).

The multi transaction translator indicator provided with the lookup request (e.g., the multi-TT indicator included in the split packet request) is provided to the input of an inverter 1430 and the multi transaction translator indicator stored the associative array 170 (e.g., the multi transaction translator indicator associated with the particular identifier being tested) is provided to the input of an inverter 1440. The outputs of inverters 1430 and 1440 are coupled to the inputs of an AND gate 1450. According to other embodiments, one or more of the inverters 1430 and 1440 may be omitted.

The outputs of the comparator 1420 and the AND gate 1450 are coupled to the inputs of an OR gate 1460. The outputs of the comparator 1410 and the OR gate 1460 are provided to the inputs of an AND gate 1470 along with the valid indicator that is stored the associative array 170 (e.g., the valid indicator associated with the particular identifier being tested). According to another embodiment, the valid indicator is not provided to the input of the AND gate 1470.

FIG. 15 is a block diagram of a system 1500 illustrating the dataflow of a split packet request 1510 through the host controller 140 and the interaction between various host controller components during the execution of the split packet request 1510, according to one embodiment. To initiate a transfer between a target low-speed or full-speed device 1520 that is attached to a high-speed hub 1530, system software, such as the OS, device drivers, or client drivers, generates a transaction request and rings a doorbell to alert the primary scheduler 616 (FIG. 6) that an endpoint needs servicing. After the primary scheduler 616 determines when to execute the transaction and requests the list processor 618 to service that transaction, the list processor 618 generates a split packet request and transmits the split packet request to the encapsulator 146 via the DMA engine 620. As described in more detail below, the split transaction controllers 1580 can also post a request to the list processor 618 to resend the split packet request. The hub 1530 includes a transaction translator 1532 that converts high-speed split transactions to low-speed or full-speed transactions for the device 1520. The hub 1530 is coupled to the host controller 140 via a high-speed bus 1540 (e.g., having a USB high-speed data transfer rate of approximately 480 megabits per second). The device 1520 is coupled to the hub 1530 via a low-speed or full-speed bus 1550 (e.g., having a USB low-speed data transfer rate of approximately 1.5 megabits per second or a USB full-speed data transfer rate of approximately 12 megabits per second).

The encapsulator 146 illustrated in FIG. 15 includes a tagging module or agent 1560 that is configured to tag the split packet request 1510 with a unique identifier (e.g., TTID) from the associative array 170 and tag the split packet request 1510 with a packet execution resource (e.g., a packet number, packet pointer, resource handle, or other resource identifier) based on data stored in the state memory 710. After the encapsulator 146 receives or accesses the split packet request 1510, the identifier tagging module or agent 1320 requests a lookup in the associative array 170 to determine the unique identifier or TTID that has been allocated to the downstream transaction translator 1532. If a unique identifier has not been allocated to the transaction translator 1532, a unique identifier will be allocated as described with reference to FIGS. 9 and 12. After the associative array 170 returns the TTID, the identifier tagging module 1320 tags the split packet request 1510 with the returned TTID, which becomes part of the information tag throughout the execution of the split packet request 1510. It should be noted that the TTID is not sent across busses 1540 and 1550.

The split packet request 1510 includes information the host controller 140 uses to communicate with the target device 1520, such as the address of the device 1520, the endpoint address (e.g., the uniquely addressable portion of the device 1520 that is the source or sink of data), the endpoint direction (e.g., IN or OUT), and the byte count. To facilitate a lookup in the associative array 170, the split packet request 1510 also includes the address of the hub 1530, the port number on the hub 1530 to which the device 1520 is attached, and an indication of whether the hub 1530 includes a single transaction translator or multiple transaction translators.

According to one embodiment, the split packet request 1510 comprises a wide word that includes a plurality of bits that describe the information the host controller 140 uses to communicate with the target device 1520. Table 3 illustrates the various fields of a wide word that makes up the split packet request 1510, according to one embodiment. Split packet requests according to other embodiments may omit one or more of the fields illustrated in Table 3, include additional fields, or both.

TABLE 3

| Field | Width (Bits) | Brief Description |
|---|---|---|
| Device Address | 7 | A seven-bit value representing the address of a device |
| | | (e.g., the device 1520 in FIG. 15) on the bus. |
| Endpoint Number | 4 | A four-bit value associated with an endpoint on a device. |
| Byte Count | 11 | An eleven-bit value reflecting the number of bytes |
| | | associated with the split transaction. |
| Endpoint Type | 2 | A two-bit value specifying the endpoint type (e.g., |
| | | interrupt, isochronous, bulk, or control). |
| Endpoint Direction | 2 | A two-bit value specifying the direction of data transfer |
| | | (e.g., IN, OUT, SETUP, or PING). |
| Set Address | 1 | A one-bit value indicating whether the transaction |
| | | includes a set address packet (e.g., a request that sets |
| | | the device address for all future device accesses). |
| Control Status | 1 | A one-bit value indicating a control status phase. |
| Data Sequence | 2 | A two-bit value indicating a data packet sequence (e.g., |
| | | DATA0, DATA1, DATA2, and MDATA). |
| Speed | 4 | A four-bit value indicating xHCI speed (e.g., full-speed, |
| | | low-speed, high-speed, or super-speed). |
| Hub Address | 7 | A seven-bit value representing a device address of the |
| | | target hub (e.g., the hub 1530) on the bus. |
| Port Number | 7 | A seven-bit value representing a port number of the |
| | | hub that the split transaction is targeting. |
| Multi-TT | 1 | A one-bit value indicating the number of transaction |
| | | translators that are within the hub (e.g., one transaction |
| | | translator per port or one transaction translator that is |
| | | shared by all ports). |
| Start/Complete | 1 | A one-bit value indicating whether the split transaction |
| State | | is in the start state or complete state. |
| S-Bit | 1 | A one-bit value indicating the split S-bit (e.g., the speed |
| | | field in FIG. 5 indicating a low-speed or full-speed |
| | | transaction). The S-bit value is added to the wide word |
| | | by the encapsulator 146 and is place holder in the split |
| | | packet request. |
| EU-Bit | 1 | A one-bit value indicating the split EU-bit (e.g., the end |
| | | field 560 in FIG. 5). The EU-bit value is added to the |
| | | wide word by the encapsulator 146 and is place holder |
| | | in the split packet request. The S-bit and EU-bit may |
| | | be used together to designate the start, beginning, |
| | | middle, or end of an isochronous OUT transaction. |
| | | The EU-bit is generally “0” except for isochronous OUT |
| | | transactions. |
| MaxPacketSize | 11 | An eleven-bit value reflecting the maximum packet size |
| | | the endpoint is capable of sending or receiving. |
| TTID | N | The TTID value is added to the wide word by the |
| | | identifier tagging module 1320 and is place holder in |
| | | the split packet request. The TTID value is generally |
| | | not valid when the split packet request is received by |
| | | the encapsulator (e.g., all bits may be set to “0”). The |
| | | width of the TTID may vary depending on the number |
| | | of TTIDs provided in the associative array (e.g., 5 bits |
| | | for 32 TTIDs). |
| Split Packet | 1 | A one-bit value indicating the source of the split packet |
| Request Source | | request. A “0” indicates that the primary scheduler 616 |
| | | (FIG. 6) made the request. A “1” indicates that the |
| | | split transaction controller 1580 made the request, such |
| | | as when the split transaction controller 1580 requests |
| | | the transaction to be resent (additional details of which |
| | | are discussed below). |
| Overlap Flag | 1 | A one-bit value used to flag special handling of IN split |
| | | transaction with one-millisecond timing. For example, |
| | | the overlap flag may be used to indicate that the data |
| | | sequence number DATA0/DATA1 may not be correct |
| | | in the split packet request because there may be a |
| | | request in the opposite bank of odd/even packet lists |
| | | (INs only) that may affect the sequence number. Until |
| | | the packet with the same EP/ADDR finishes in the |
| | | previous packet list, the data sequence number |
| | | generally cannot be determined. When the overlap flag |
| | | is set to “1,” the encapsulator 146 verifies the data |
| | | sequence number against what is passed in the re- |
| | | request phase (after a complete-split) instead of the |
| | | primary phase. |
| Split Phase | 1 | A one-bit value indicating a start or complete phase |
| Request | | request. A zero indicates that the transaction should |
| | | start from the start-split state. A one indicates that the |
| | | transaction should start directly from the complete-split |
| | | state. |

After the encapsulator 146 receives the split packet request 1510 (e.g., from the DMA engine 620 in FIG. 6), the split packet request 1510 is handed to the identifier tagging module 1320, which holds the split packet request 1510 for one or more clock cycles while a lookup is performed in the associative array 170. After the split packet request 1510 is tagged with the TTID, the identifier tagging module 1320 presents the tagged split packet request 1510 to a transaction number tagging module 1570, which tags the split packet request 1510 with a packet execution resource, such as a packet number. The packet execution resource becomes part of the information tag throughout the execution of the split packet request 1510. It should be noted that the TTID and packet execution resource are not sent across busses 1540 and 1550.

For each downstream transaction translator, a specific number of packets-in-progress are reserved per identifier instance (e.g., TTID instance). For example, two asynchronous and fifteen periodic packet execution resources may be reserved per transaction translator. According to one embodiment, the transaction number tagging module 1570 tags the split packet request 1510 with a packet number by storing all or a portion of the split packet request 1510 in the state memory 710. For example, if the split packet request 1510 involves a periodic transaction, packet information associated with the split packet request 1510 is stored in the next available memory location in an appropriate periodic packet list (e.g., one of the memory locations 1023 through 1027 in packet list 1022 of FIG. 10, for example). Because the state memory 710 is indexed by the unique identifier (e.g., TTID) and the packet execution resource (e.g., packet number), the TTID assigned to the split packet request 1510 helps determine the appropriate packet list in which to store the packet information.

The packet information stored in the state memory 710 may include one or more of the device address, endpoint address, endpoint direction (e.g., IN or OUT), byte count, hub address, hub port number, single or multiple transaction translator indicator, packet phase (e.g., start-split or complete-split), isochronous OUT packet phase (e.g., start-split all, begin, mid, or end as indicated in the S&E fields), and fraction of packet length remaining to be transferred. According to one embodiment, the TTID and packet number are not stored in the state memory 710 along with the packet information. Instead, the TTID and packet number form the address of the memory location in the state memory 710. However, certain embodiments may store the TTID and packet number along with the packet information in the state memory 710.

After the split packet request 1510 is tagged with an identifier by the identifier tagging module 1320 and tagged with the packet execution resource (e.g., stored in an appropriate packet list in state memory 710), the tagging module 1560 sends a trigger 1562 to one or more split transaction controllers 1580 so that those controllers can execute a split transaction (e.g., start-split or complete-split transaction) corresponding to the split packet request 1510 at some later point (e.g., in a subsequent one-millisecond frame for periodic transactions). In other words, the TTID and packet number tagged split packet request 1510 does not flow directly from the tagging module 1560 to the split transaction controllers 1580. Instead, the split packet request 1510 is routed through the state memory 710, which is shared by the tagging module 1560 and the split transaction controllers 1580. In other words, the split packet request 1510 is stored in the state memory 710 and is later retrieved by one of the split transaction controllers 1580. The split transaction controllers 1580 may, for example, include one or more of an asynchronous execution engine, a periodic execution engine, and a completion engine.

At an appropriate frame interval (e.g., for periodic transactions), one of the split transaction controllers 1580 accesses the state memory 710 to execute the split transactions (including the split transaction corresponding to the split packet request 1510) stored in the packet lists in the state memory 710. The split transaction corresponding to the split packet request 1510 is provided to a protocol layer 1590 (e.g., buffers 676 or 678, the protocol layer 680, and the port manager 682 in FIG. 6), which causes the split transaction to move across the high-speed bus 1540, through the transaction translator 1532 in the hub 1530, across the low-speed or full-speed bus 1550, and to the device 1520. The device 1520 may then send an acknowledgment (e.g., an ACK or NAK packet) or data (e.g., if the split packet request 1510 was an IN transaction) across the low-speed or full-speed bus 1550, through the transaction translator 1532, onto the high-speed bus 1540, and to the protocol layer 1590.

After the protocol layer 1590 receives the acknowledgment (or data), one of the split transaction controllers 1580 (e.g., a completion engine) may update state information stored in the state memory 710 to reflect the full or partial execution of the split packet request 1510. For example, if an acknowledgement from a start-split transaction for the split packet request 1510 is received, the state information stored in the state memory 710 is updated to indicate that a complete-split transaction can be sent. By way of another example, if an acknowledgement from a complete-split transaction for the split packet request 1510 is received, the state information associated with the split packet request 1510 may be cleared from the state memory 710. The TTID and packet number, which were passed down to the split transaction controllers 1580, are used to access the appropriate memory location in the state memory 710 (i.e., the TTID and packet number form the address in state memory 710). In other embodiments, the hub address, port number, and multi-TT indicator are passed down to the split transaction controllers 1580 (instead of the TTID and packet number) and another lookup is performed after the acknowledgment or data is received from the hub 1530.

After the acknowledgment or data is received (and possibly after state information is updated), a split packet result 1595 is provided to the system software (e.g., the data from the device 1520 is posted to the buffer designated by the device driver or a confirmation that an OUT packet was sent successfully is provided to the device driver).

According to one embodiment, the split transaction controllers 1580 are configured to post a request to the TRM or list processor 618 requesting the list processor 618 to resend or repeat the split packet request 1510. Requesting the split packet request 1510 to be resent helps minimize the amount of data that is stored in the state memory 710 and, thus, helps keep the amount of memory used to implement the state memory 710 to a minimum. For example, by re-requesting the split packet request 1510, all of the header fields and the data payload associated with the split packet request 1510 do not need to be stored in the state memory 710 (or elsewhere, such as in the DMAs 620 in FIG. 6). Data storage alone may require the use of a relatively large amount of memory, particularly when there are many active transaction translator IDs.

Thus, with reference to FIGS. 6 and 15, the split packet request 1510 may be initiated by the primary scheduler 616 or the split transaction controllers 1580. The split packet request source field (see Table 3) included in the split packet request 1510 indicates the source of the split packet request 1510. If the primary scheduler 616 initiates the split packet request 1510, the list processor 618 gathers the data used to form the split packet request 1510 and passes the split packet request 1510 to the encapsulator 146 via the DMA engine 620. After the encapsulator 146 receives the split packet request 1510, the identifier tagging module 1320 tags the split packet request 1510 with a TTID and the transaction number tagging module 1570 tags the split packet request 1510 with a packet execution resource. If the split transaction controllers 1580 initiate the split packet request 1510, the list processor 618 again gathers the data used to form the split packet request 1510 (which may involve request the transfer request block from the system memory again) and passes the re-requested split packet request 1510 to the encapsulator 146 via the DMA engine 620. The tagging module 1560 preferably does not tag the re-requested split packet request 1510 with a new TTID and a new packet execution resource. Instead, the tagging module 1560 may pair the re-requested split packet request 1510 with the previously stored split packet request.

The dataflow through the host controller 140 may vary depending on the whether the transaction involves an asynchronous IN, asynchronous OUT, periodic IN, or periodic OUT transaction. If the split packet request 1510 relates to an asynchronous OUT transaction, there typically is no need to re-request the split packet request 1510. Instead, the primary scheduler 616 makes an initial request for the split packet request 1510 and an outbound DMA engine pairs the split packet request 1510 up with the necessary data movement. After the encapsulator 146 receives the split packet request 1510, the tagging module 1560 tags the split packet request 1510 with a TTID and packet execution resource and stores all or a portion of the split packet request 1510 in the state memory 710, and a start-split transaction for the split packet request 1510 is dispatched along with the outbound data (e.g., by an asynchronous execution engine 1640 (FIG. 16) in response to a trigger). At some later point in time, a complete-split transaction is dispatched and the response to the complete-split transaction is sent to the list processor 618 along a return path.

If the split packet request 1510 relates to an asynchronous IN transaction, the primary scheduler 616 makes an initial request for the split packet request 1510 and an inbound DMA engine forwards the split packet request 1510 to the encapsulator 146 but does not store the data buffer pointer (e.g., one or more pointers to a host memory buffer into which inbound data from the device is stored). After the encapsulator 146 receives the split packet request 1510, the tagging module 1560 tags the split packet request 1510 with a TTID and packet execution resource and stores all or a portion of the split packet request 1510 in the state memory 710, and a start-split transaction for the split packet request 1510 is dispatched (e.g., by the asynchronous execution engine 1640 in response to a trigger). At some later point in time, a complete-split transaction is dispatched and the split packet request 1510 is re-requested. For example, a completion engine 1660 (FIG. 16) may post a request to the list processor 618 to resend the split packet request 1510. After the list processor 618 gathers the data used to form the re-requested split packet request 1510, the re-requested split packet request 1510 is passed to the encapsulator 146 via the inbound DMA engine, which preferably stores the data buffer pointer (e.g., within local storage of the inbound DMA, which may be sized to store N pointers per root port plus N pointers for the encapsulator). After the encapsulator 146 receives the re-requested split packet request 1510, the tagging module 1560 preferably does not tag the re-requested split packet request 1510 with a new TTID and a new packet execution resource because the initial split packet request 1510 should already be stored in the state memory 710. After a response is received from the complete-split transaction, the response is sent along with the inbound data to the list processor 618 via a return path (e.g., with reference to FIG. 6, the response moves from the port manager 682 up through the protocol layer 680, into the asynchronous buffer 676, and eventually onto the bus 128 via the root hub 634, the inbound DMA engine, the list processor 618, and the bus interface 612).

If the split packet request 1510 relates to a periodic OUT transaction, the primary scheduler 616 makes an initial request for the split packet request 1510 and an outbound DMA engine forwards the split packet request 1510 to the encapsulator 146 without the outbound data. After the encapsulator 146 receives the split packet request 1510, the tagging module 1560 tags the split packet request 1510 with a TTID and packet execution resource and stores all or a portion of the split packet request 1510 in the state memory 710. At the appropriate time, a periodic execution engine 1650 (FIG. 16) posts a request to the list processor 618 to resend the split packet request 1510. If the data packet is more than 188 bytes (e.g., an isochronous transfer), the periodic execution engine 1650 preferably only requests the data packet fragment(s) that will be sent during the microframe. The periodic execution engine 1650 can request additional data fragments at some later point with one or more additional repeat requests until the entire data packet is dispatched in subsequent microframes. After the list processor 618 gathers the data used to form the re-requested split packet request 1510, the re-requested split packet request 1510 is passed to the encapsulator 146 via the outbound DMA engine, which pairs the re-requested split packet request 1510 up with the necessary data movement. After the encapsulator 146 receives the re-requested split packet request 1510, the tagging module 1560 preferably does not tag the re-requested split packet request 1510 with a new TTID and a new packet execution resource because the initial split packet request 1510 should already be stored in the state memory 710. Instead, one or more of the fields in the re-requested split packet request 1510 (e.g., one or more of the fields illustrated in Table 3) may be inspected (e.g., by the tagging module 1560) and the data in the inspected field(s) may be used to update the data stored in the state memory 710 (e.g., the data in the state memory 710 associated with the initial split packet request 1510). For example, in an overlap case, the data packet sequence number (DATA0/DATA1) may not be reliable on first request but should be reliable in the re-requested split packet request 1510 because the previous packet should be executed. After the encapsulator 146 receives the re-requested split packet request 1510 and the outbound data, the periodic execution engine 1650 causes a start-split transaction for the split packet request 1510 to be dispatched along with the outbound data. At some later point in time, a complete-split transaction is dispatched and the response to the complete-split transaction is sent to the list processor 618 along a return path (e.g., with reference to FIG. 6, the response moves from the port manager 682 up through the protocol layer 680, into the periodic buffer 678, and eventually onto the bus 128 via the root hub 634, the outbound DMA engine, the list processor 618, and the bus interface 612).

If the split packet request 1510 relates to a periodic IN transaction, the primary scheduler 616 makes an initial request for the split packet request 1510 and an inbound DMA engine forwards the split packet request 1510 to the encapsulator 146 but does not store the data buffer pointer (e.g., one or more pointers to a host memory buffer into which inbound data from the device is stored). After the encapsulator 146 receives the split packet request 1510, the tagging module 1560 tags the split packet request 1510 with a TTID and packet execution resource and stores all or a portion of the split packet request 1510 in the state memory 710 and a start-split transaction for the split packet request 1510 is dispatched at the appropriate time (e.g., by the periodic execution engine 1650 in FIG. 16). At some later point in time, a complete-split transaction is dispatched and the split packet request 1510 is re-requested. For example, the completion engine 1660 (FIG. 16) may post a request to the list processor 618 to resend the split packet request 1510. After the list processor 618 gathers the data used to form the re-requested split packet request 1510, the re-requested split packet request 1510 is passed to the encapsulator 146 via the inbound DMA engine, which preferably stores the data buffer pointer (e.g., within local storage of the inbound DMA, which may be sized to store N pointers per root port plus N pointers for the encapsulator). Because the inbound data packet may come back in fragments, the periodic execution engine 1650 may post multiple requests to the list processor 618 to resend the split packet request 1510 multiple times to prime the inbound DMA engine with the appropriate data buffer pointer after the data packet(s) arrives with the complete-split token. After the encapsulator 146 receives the re-requested split packet request 1510, the tagging module 1560 preferably does not tag the re-requested split packet request 1510 with a new TTID and a new packet execution resource because the initial split packet request 1510 should already be stored in the state memory 710. Instead, one or more of the fields in the re-requested split packet request 1510 (e.g., one or more of the fields illustrated in Table 3) may be inspected (e.g., by the tagging module 1560) and the data in the inspected field(s) may be used to update the data stored in the state memory 710 (e.g., the data in the state memory 710 associated with the initial split packet request 1510). For example, in an overlap case, the data packet sequence number (DATA0/DATA1) may not be reliable on first request but should be reliable in the re-requested split packet request 1510 because the previous packet should be executed. After a response is received from the complete-split transaction, the response is sent along with the inbound data to the list processor 618 via a return path (e.g., with reference to FIG. 6, the response moves from the port manager 682 up through the protocol layer 680, into the periodic buffer 678, and eventually onto the bus 128 via the root hub 634, the inbound DMA engine, the list processor 618, and the bus interface 612).

FIG. 16 is a block diagram illustrating additional details of the encapsulator 146 of FIG. 15, according to one embodiment. After the tagging module 1560 receives or accesses the split packet request 1510, the tagging module 1560 sends a request (1610) to the associative array 170 to lookup the TTID. After the associative array 170 returns the TTID, the tagging module 1560 accesses an appropriate state memory using the returned TTID (e.g., one of the TT state memories 712 through 716) and allocates (1612) a packet number to the split packet request 1510. For example, the tagging module 1560 may check an appropriate packet counter (e.g., one of the asynchronous packet counters 1010, 1040, or 1070 or periodic packet counters 1020, 1050, or 1080 in FIG. 10) or search for the next available memory location in an appropriate packet list (e.g., one of the memory locations 1023 through 1027 in packet list 1022 of FIG. 10, for example). After the tagging module 1560 allocates a packet number to the split packet request 1510, the tagging module 1560 stores (1614) all or a portion of the split packet request 1510 in the appropriate memory location (e.g., one of the memory locations 1631 through 1633) and possibly increments the appropriate counter. In other words, after the tagging module 1560 receives the split packet request 1510 and allocates a TTID and packet number, the tagging module 1560 posts the split packet request 1510 to a list of packets (e.g., packet list 1630) to be executed.

The encapsulator 146 illustrated in FIG. 16 includes an asynchronous execution engine 1640, a periodic execution engine 1650, and a completion engine 1660 in the secondary scheduler 632, which execute transactions included in the packet lists (e.g., packet list 1630) stored in the state memory 710. The periodic execution engine 1650 executes periodic transactions on the packet lists during a predetermined time interval (e.g., an upcoming microframe). The asynchronous execution engine 1640 is opportunistic. After a split packet request is posted to an asynchronous packet list in one of the state memories 712 through 716, the asynchronous execution engine 1640 receives a trigger from a trigger circuit 1616 and executes the asynchronous transaction.

The TT state memories 712 through 716 include valid flags or bits 1634 through 1636 that are associated with the memory locations 1631 through 1633. In other words, valid flag 1634 is associated with memory location 1631, valid flag 1635 is associated with memory location 1632, and valid flag 1636 is associated with memory location 1633. When the split packet request 1510 is stored in one of the memory locations 1631 through 1633, the tagging module 1560 sets the valid flag associated with that memory location to indicate that a split packet request is stored in that memory location (e.g., the valid flag is set to a logical “1”). When the asynchronous and periodic execution engines 1640 and 1650 read the packet lists in the state memories 712 through 716, the valid flags are examined to determine which memory locations contain valid transactions. Because the TTID and packet number form the address of the memory locations 1631 through 1633, the execution engines 1640 and 1650 transmit to the protocol layer 1590 the TTID and packet number along with the contents of a particular memory location. In other words, the TTID and packet number are known by virtue of accessing a particular memory location.

After the protocol layer 1590 transmits a given transaction to the downstream hub and receives a response (e.g., an acknowledgement handshake) back from that hub, the protocol layer 1590 transmits to the completion engine 1660 the acknowledgment along with the TTID and packet number. Because the TTID and packet number were previously transmitted to the protocol layer 1590 from the execution engines 1640 and 1650, the protocol layer 1590 is able to send the correct TTID and packet number associated with the received acknowledgment. In other words, after transmitting a given transaction to a downstream hub, the protocol layer 1590 waits for a response from the hub. Because the protocol layer 1590 sends a request and waits for a response to that request (e.g., only one request is sent at a time), the response coming back from the hub is assumed to be from the last-sent request.

After receiving the response, TTID, and packet number, the completion engine 1660 can update state information in an appropriate state memory 712 through 716 to reflect the full or partial execution of the split packet request. For example, if an acknowledgement from a start-split transaction is received, the state information is updated to indicate that a complete-split transaction can be sent. By way of another example, if the protocol layer 1590 transmits a complete-split token along with an IN token to the downstream hub and receives a data packet back, the state memory (which is indexed by the TTID and packet number associated with the complete-split transaction) can be updated to indicate that the data packet was received.

FIG. 17 is a simplified state diagram 1700 illustrating various states of one of the host controller state machines in the set of state machines 144 of FIG. 1, according to one embodiment. When the host controller 140 powers up, the state machine enters a normal operation state 1710. After a user attaches a hub to the host 120, for example, the state machine enters a configuration state 1720 in which the host controller 140 configures the hub. For example, during the configuration state 1720, the host 120 may read the hub's device descriptors to determine how to configure the hub, assign a unique address to the hub, power up the ports on the hub, and determine whether the hub includes a single transaction translator or multiple transaction translators. After the hub is configured, the state machine returns to the normal operation state 1710.

To initiate a transfer between a target low-speed or full-speed device that is attached to a high-speed hub, system software, such as the OS, device drivers, or client drivers, generates a transaction request and rings a doorbell to alert the primary scheduler 616 (FIG. 6) that an endpoint needs servicing. After the primary scheduler 616 determines when to execute the transaction and requests the list processor 618 to service that transaction, the list processor 618 generates a split packet request and transmits the split packet request to the encapsulator 146 via the DMA engine 620. After the encapsulator 146 receives the split packet request, the state machine enters a lookup state 1730. During the lookup state 1730, a lookup operation is performed against the data in the associative array 170 to retrieve a TTID that has been allocated to the transaction translator for which the split transaction is destined. The lookup operation is performed using as the key information carried with the split packet request (e.g., the hub address, the hub port number, and multi-TT indicator). If a TTID value is found using the key, the TTID value is returned to the host controller 140 and the state machine transitions from the lookup state 1730 to a TTID tagging state 1740. If, on the other hand, a TTID value is not found using the key, the state machine transitions from the lookup state 1730 to an allocation state 1750. During the allocation state 1750, an unused TTID value in the associative array 170 is allocated to the target transaction translator. After a TTID value has been allocated to the target transaction translator, the allocated TTID value is returned to the host controller 140 and the state machine transitions from the allocation state 1750 to the TTID tagging state 1740. Additional details regarding the performing a lookup in an associative array and allocating an unused TTID value to a transaction translator are described with reference to FIGS. 8, 9, and 12-14.

During the TTID tagging state 1740, the split packet request is tagged with the TTID that was found during the lookup state 1730. Additional details regarding tagging the split packet request with the TTID are described with reference to FIGS. 15 and 16. After the split packet request is tagged with the TTID, the state machine transitions from the TTID tagging state 1740 to a packet number allocation state 1760. During the packet number allocation state 1760, a packet execution resource, such as a packet number in a packet list, is allocated to the split packet request. Additional details regarding allocating to the split packet request a packet execution resource are described with reference to FIGS. 12, 15 and 16. After a packet execution resource is allocated to the split packet request, the state machine transitions from the packet number allocation state 1760 to a state information storing state 1770.

During the state information storing state 1770, the host controller 140 may store or update general state information (e.g., increment a packet counter and/or add the number of bytes associated with the transaction to a bytes-in-progress counter) and store or update packet state information (e.g., store in a state memory information, such as the device address, endpoint address, endpoint direction, byte count, hub address, hub port number, multi-TT indicator, packet phase, isochronous OUT packet phase, and fraction of packet length remaining to be transferred). Additional details regarding storing or updating state information are described with reference to FIGS. 12, 15 and 16. After the state information is stored or updated, the state machine transitions from the state information storing state 1770 to a start-split execution state 1780.

During the start-split execution state 1780, the host controller 140 executes a start-split transaction (for the split packet request) to the appropriate transaction translator. If the transaction translator responds with a NAK handshake (e.g., a negative acknowledgement handshake packet), the host controller 140 remains in the start-split execution state 1780 and executes the same start-split transaction again at another time. If, on the other hand, the transaction translator responds with an ACK handshake (e.g., a positive acknowledgement handshake packet), the state machine transitions from the start-split execution state 1780 to a state information updating state 1785.

It should be noted that the start-split execution state 1780 and complete-split execution state 1790 illustrated in FIG. 17 represent the execution of an asynchronous split transaction. The execution of a periodic split transaction would differ (e.g., the host controller 140 would not expect to receive an ACK handshake after executing a start-split transaction). In addition, the start-split execution state 1780 and complete-split execution state 1790 illustrated in FIG. 17 are greatly simplified for illustration purposes (e.g., error conditions are not illustrated).

During the state information updating state 1785, the host controller 140 updates state information in an appropriate state memory (e.g., state memories 712 through 716 in FIG. 16) to reflect the full or partial execution of the split packet request (e.g., a start-split/complete-split field may be updated to reflect that the split packet request is in the complete-split phase or a bytes-in-progress counter may be updated). After the state information is stored or updated, the state machine transitions from the state information updating state 1785 to a complete-split execution state 1790.

During the complete-split execution state 1790, the host controller 140 executes a complete-split transaction (for the split packet request) to the appropriate transaction translator. If the transaction translator responds with a NYET handshake, which may be returned by the hub in response to a split transaction when the low-speed or full-speed transaction has not yet been completed or the hub is otherwise not able to handle the split transaction, the host controller 140 remains in the complete-split execution state 1790 and executes the same complete-split transaction again at another time. If the transaction translator responds with a NAK handshake, the host controller 140 returns to the start-split execution state 1780 and executes another start-split transaction (e.g., the host controller 140 resends the split packet request). Thus, if a NAK handshake is received in response to either a start-split or complete-split, the packet state element will be freed and the primary scheduler (e.g., the primary scheduler 616 in FIG. 6) reissues the packet so that a device that responds with a negative acknowledgement (i.e., a NAKing device) does not lock the encapsulator resource that is trying to finish. The primary scheduler is preferably configured to ensure fairness among other endpoints competing for asynchronous encapsulator resources. If the transaction translator responds with an ACK handshake, the state machine transitions from the complete-split execution state 1790 to the normal operation state 1710.

Before the state machine transitions from the complete-split execution state 1790 to the normal operation state 1710, the host controller 140 may notify the system software (e.g., the OS or USB driver) that made the transaction request that the transaction has completed and update a valid flag associated with a state memory location (e.g., one of the valid flags 1634 through 1636 that are associated with the memory locations 1631 through 1633 in FIG. 16) so that the state memory location may be reused for a different split packet request.

If a hub is detached from the host controller 140, the state machine transitions from the normal operation state 1710 to a deallocation state 1715. During the deallocation state 1715, any TTID values that were allocated to transaction translators within the detached hub are deallocated so that the TTID value(s) can be allocated to a different transaction translator. After the TTID value(s) are deallocated, the state machine transitions from the deallocation state 1715 to the normal operation state 1710.

Embodiments may be provided as a computer program product including a nontransitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be via CD-ROM or via Internet download.

The terms and descriptions used above are set forth by way of illustration only and are not meant as limitations. Those skilled in the art will recognize that many variations can be made to the details of the above-described embodiments without departing from the underlying principles of the invention. The scope of the invention should therefore be determined only by the following claims and their equivalents.

1. A method of processing a transaction for execution over a multi-speed bus including a root hub coupled to a device via an intermediate hub, the intermediate hub coupled to the root hub via a first bus operating at a first communication speed and the device coupled to the intermediate hub via a second bus operating at a second communication speed different from the first speed, wherein the intermediate hub includes at least one data forwarding component configured to translate transactions transferred over the first bus at the first speed to transactions transferred over the second bus at the second speed, the method comprising:
receiving a split packet request defining a transaction with the device, the split packet request including intermediate-hub data defining parameters used to communicate with the device via the intermediate hub;
performing a lookup in an associative array using the intermediate-hub data to determine whether an identifier is allocated to a data forwarding component included in the intermediate hub, the associative array mapping intermediate-hub data to a corresponding identifier; and
if it is determined, based on the lookup, that an identifier is allocated to the data forwarding component included in the intermediate hub, tagging the split packet request with the identifier allocated to the data forwarding component.

2. A method according to claim 1, further comprising:
tagging the split packet request with a packet execution resource, the packet execution resource indicative of a total number of outstanding transactions awaiting translation by the data forwarding component.

3. A method according to claim 2, further comprising:
storing in a storage location of a state memory state information associated with the split packet request to reflect the transaction defined by the split packet request, the storage location having an address defined by the identifier and the packet execution resource.

4. A method according to claim 3, further comprising:
executing the transaction defined by the split packet request;
after the transaction defined by the split packet request has been executed, updating a valid flag associated with the storage location to indicate that the split packet request has been executed so that the storage location may be reused to store state information for a different split packet request; and
storing state information associated with the different split packet request in the storage location.

5. A method according to claim 3, wherein the step of storing state information associated with the split packet request comprises storing the split packet request in the storage location of the state memory.

6. A method according to claim 3, wherein the step of storing state information associated with the split packet request comprises updating data concerning a total number of asynchronous packets-in-progress.

7. A method according to claim 3, wherein the step of storing state information associated with the split packet request comprises updating data concerning a total number of periodic packets-in-progress.

8. A method according to claim 3, wherein the step of storing state information associated with the split packet request comprises updating data concerning a total number of bytes-in-progress.

9. A method according to claim 1, wherein at least a portion of the data associated with the split packet request is not stored in a state memory and further comprising:
requesting the same split packet request to be resent so that the portion of the data associated with the split packet request that is not stored in the state memory is available to facilitate execution of the transaction defined by the split packet request.

10. A method according to claim 1, further comprising:
if it is determined, based on the lookup, that an identifier is not allocated to the data forwarding component included in the intermediate hub, allocating an identifier to the data forwarding component included in the intermediate hub.

11. A method according to claim 1, further comprising:
deallocating the identifier from the data forwarding component so that the identifier can be allocated to a different data forwarding component; and
allocating the identifier to a different data forwarding component.

12. A method according to claim 1, wherein the intermediate-hub data included in the split packet request comprise an address of the intermediate hub that includes the data forwarding component, a port number on the intermediate hub to which the device is coupled, and an indication of whether the intermediate hub includes a single data forwarding component that is shared by all downstream ports on the intermediate hub or one data forwarding component per downstream port.

13. A method according to claim 12, wherein the step of performing the lookup is implemented in logic, the logic defined by a function of the form:
$${Match}_{i} = {valid}_{i} AND \\ ( {tt}_{{addr}_{i}} = {tt}_{{addr}_{lookup}} ) AND \\ ( \begin{matrix}( {tt}_{{portnum}_{i}} = {tt}_{{portnum}_{lookup}} ) OR \\ ( NOT {tt\_mult}_{i} AND NOT {tt\_multi}_{lookup} )\end{matrix} )$$
wherein i corresponds to the identifier, which has a value ranging from 0 to N-1, N corresponds to a maximum number of identifiers stored in the associative array, valid, is 0 if the identifier is not correlated to intermediate-hub data or 1 if the identifier is correlated to intermediate-hub data, tt_addrᵢ is the address of the intermediate hub that is mapped to a corresponding identifier, tt_portnumᵢ is the port number on the intermediate hub that is mapped to a corresponding identifier, tt_multiᵢ is 0 if the intermediate hub supports one data forwarding component or 1 if the intermediate hub supports more than one data forwarding component, tt_addrₗₒₒₖᵤₚ, tt_portnumₗₒₒₖᵤₚ, and tt_multiₗₒₒₖᵤₚ correspond to the address of the intermediate hub, the port number of the intermediate hub, and the multi-data-forwarding-component indicator included in the split packet request, respectively, and Matchᵢ returns 0 if the intermediate-hub data is not mapped to an identifier or 1 if the intermediate-hub data is mapped to an identifier.

14. A method according to claim 1, wherein the first and second buses comprise USB buses.

15. A method according to claim 1, wherein the downstream data forwarding component comprises a transaction translator operating according to the USB specification revision 2.0.

16. A system comprising:
a means for communicating with an intermediate hub via a first data communication means operating at a first communication speed, the intermediate hub configured to communicate with a device via a second data communication means operating at a second communication speed different from the first speed, the intermediate hub including at least one data forwarding means configured to translate transactions transferred over the first data communication means at the first speed to transactions transferred over the second data communication means at the second speed;
a means for receiving a split packet request defining a transaction with the device, the split packet request including intermediate-hub data defining parameters used to communicate with the device via the intermediate hub;
a means for performing a lookup in an associative array using the intermediate-hub data to determine whether an identifier is allocated to a data forwarding means included in the intermediate hub, the associative array mapping intermediate-hub data to a corresponding identifier; and
a means for tagging the split packet request with the identifier allocated to the data forwarding means.

17. A system comprising:
a root hub including N ports, at least one port configured to communicate with a downstream hub over a first bus having a first data transfer rate, the downstream hub configured to communicate with a downstream device over a second bus having a second data transfer rate different from the first data transfer rate, the downstream hub including at least one data forwarding component configured to translate a first transaction transferred over the first bus at the first data transfer rate to a second transaction transferred over the second bus at the second data transfer rate;
an associative array configured to store for one or more data forwarding components an identifier associated with the data forwarding component and an address of a hub that includes the data forwarding component, the address defining a location of the hub on the first bus, wherein the associative array maps the address to the identifier; and
a tagging module configured to, in response to receiving a split packet request including an address of a downstream hub including a data forwarding component, determine whether the address of the downstream hub is mapped to an identifier in the associative array and, if so, tag the split packet request with the identifier mapped to the hub.

18. A system according to claim 17, wherein the tagging module is further configured to tag the split packet request with a packet execution resource, the packet execution resource indicative of a total number of outstanding transactions awaiting translation by the data forwarding component included in the hub.

19. A system according to claim 18, further comprising:
a state memory including a plurality of storage locations that are indexed by an identifier and a packet execution resource, wherein the tagging module is further configured to store the split packet request in a storage location having an address defined by the identifier mapped to the hub and the packet execution resource.

20. A system according to claim 19 wherein at least a portion of the data associated with the split packet request is not stored in the state memory and further comprising:
a split transaction controller configured to request the same split packet request to be resent so that the portion of the data associated with the split packet request that is not stored in the state memory is available to facilitate execution of the transaction defined by the split packet request.

21. A system according to claim 17, further comprising:
a bytes-in-progress counter associated with each identifier stored in the associative array, the bytes-in-progress counter storing a value representing an amount of periodic data awaiting translation by the data forwarding component included in the hub corresponding to the identifier, wherein the tagging module is further configured to update the value stored in the bytes-in-progress counter corresponding to the downstream data forwarding component with an amount of data to be transmitted to the downstream data forwarding component as reflected in the split packet request.

22. A system according to claim 17, wherein the downstream data forwarding component comprises a transaction translator.

23. A system according to claim 17, wherein the downstream data forwarding component comprises a transaction translator operating according to the USB specification revision 2.0.

24. A system according to claim 17, wherein the first data transfer rate corresponds to a USB high-speed data transfer rate of approximately 480 megabits per second and the second data transfer rate corresponds to a USB full-speed data transfer rate of approximately 12 megabits per second.

25. A system according to claim 17, wherein the first data transfer rate corresponds to a USB high-speed data transfer rate of approximately 480 megabits per second and the second data transfer rate corresponds to a USB low-speed data transfer rate of approximately 1.5 megabits per second.

26. A system according to claim 17, wherein the associative array is configured to store a total number of identifiers that is less than or equal to a total number of devices supported by the root hub.

27. A system according to claim 17, wherein the associative array is configured to store 32 identifiers.

28. A system according to claim 17, wherein:
the associative array is further configured to map a valid indicator to each identifier, the valid indicator specifying whether a particular hub is correlated to an identifier; and
if it is determined that the address of the downstream hub is not mapped to an identifier in the associative array, the associative array is further configured to map the address of the downstream hub to an identifier having associated therewith a valid indicator specifying that a particular hub is not correlated thereto.

29. A system according to claim 17, wherein:
the associative array is further configured to store the following for the one or more data forwarding components:
a hub-port number of a multi-port downstream hub, the hub-port number defining a port of the multi-port downstream hub to which the downstream device is coupled, and
a multi-data-forwarding-component indicator that indicates whether the multi-port downstream hub includes one data forwarding component per port or one data forwarding component that is shared by all ports;
the associative array is further configured to map the address, the hub-port number, and the multi-data-forwarding-component indicator to the corresponding identifier;
the split packet request further includes a hub-port number of the downstream hub to which the downstream device is coupled and a multi-data-forwarding-component indicator of the downstream hub; and
the tagging module is further configured to, in response to receiving the split packet request, determine whether the address, the hub-port number, and the multi-data-forwarding-component indicator of the downstream hub are mapped to an identifier in the associative array.

30. A system according to claim 17, further comprising:
match logic associated with each identifier in the associative array, the match logic configured to determine whether the address of the downstream hub matches an address stored in the associative array; and
an encoder in communication with the match logic and the tagging module, the encoder configured to return an identifier mapped to an address stored in the associative array that matches the address of the downstream hub.

31. A host comprising:
a host bus; and
a host controller coupled to the host bus and configured to execute a transaction over an external multi-speed bus, the host controller comprising:
a root hub including N ports, at least one port configured to communicate with a downstream hub over a first bus having a first data transfer rate, the downstream hub configured to communicate with a downstream device over a second bus having a second data transfer rate different from the first data transfer rate, the downstream hub including at least one data forwarding component configured to translate a first transaction transferred over the first bus at the first data transfer rate to a second transaction transferred over the second bus at the second data transfer rate;
an associative array configured to store for one or more data forwarding components an identifier associated with the data forwarding component and an address of a hub that includes the data forwarding component, the address defining a location of the hub on the first bus, wherein the associative array maps the address to the identifier; and
a tagging module configured to, in response to receiving a split packet request including an address of a downstream hub including a data forwarding component, determine whether the address of the downstream hub is mapped to an identifier in the associative array and, if so, tag the split packet request with the identifier mapped to the hub.

32. A host according to claim 31 wherein the host comprises a computer.

33. A host according to claim 31 wherein the host comprises an embedded system.

34. A method in a host controller for tracking a state of a transaction translator within a downstream hub, the method comprising:
receiving a split packet request defining a transaction, the split packet request including a plurality of fields containing hub-specific information;
performing a lookup in an associative array using the hub-specific information to determine whether an identifier is allocated to the transaction translator, the associative array mapping hub-specific information to an identifier; and
if it is determined, based on the lookup, that an identifier is allocated to the transaction translator, storing state information associated with the split packet request to reflect the transaction defined by the split packet request.

35. A method according to claim 34, further comprising:
if it is determined, based on the lookup, that an identifier is allocated to the transaction translator, allocating a packet execution resource to the transaction associated with the split packet request.

36. A method according to claim 35, wherein the step of storing state information associated with the split packet request comprises storing the state information in a storage location of a state memory, the storage location having an address defined by the identifier and the packet execution resource.

37. A method according to claim 36, further comprising:
executing the transaction defined by the split packet request;
after the transaction defined by the split packet request has been executed, updating a valid flag associated with the storage location to indicate that the split packet request has been executed so that the storage location may be reused to store state information for a different split packet request; and
storing state information associated with the different split packet request in the storage location.

38. A method according to claim 34, wherein at least a portion of the data associated with the split packet request is not stored in a state memory and further comprising:
requesting the same split packet request to be resent so that the portion of the data associated with the split packet request that is not stored in the state memory is available to facilitate execution of the transaction defined by the split packet request.

39. A method according to claim 34, further comprising:
if it is determined, based on the lookup, that an identifier is not allocated to the transaction translator, allocating an identifier to the transaction translator.

40. A method according to claim 34, further comprising:
deallocating the identifier from the transaction translator so that the identifier can be allocated to a different transaction translator; and
allocating the identifier to a different transaction translator.

41. A method according to claim 34, wherein the hub-specific information mapped to the identifier comprises a hub address, a hub port number, and a multi-transaction-translator indicator, and the plurality of fields included in the split packet request comprise a hub-address field, a hub-port field, and a multi-transaction-translator field.

42. A method according to claim 41, wherein the step of performing the lookup is implemented in logic, the logic defined by a function of the form:
$${Match}_{i} = {valid}_{i} AND \\ ( {tt}_{{addr}_{i}} = {tt}_{{addr}_{lookup}} ) AND \\ ( \begin{matrix}( {tt}_{{portnum}_{i}} = {tt}_{{portnum}_{lookup}} ) OR \\ ( NOT {tt\_mult}_{i} AND NOT {tt\_multi}_{lookup} )\end{matrix} )$$
wherein i corresponds to the identifier, which has a value ranging from 0 to N-1, N corresponds to a maximum number of identifiers stored in the associative array, valid, is 0 if the identifier is not correlated to hub-specific information or 1 if the identifier is correlated to hub-specific information, tt_addrᵢ is the hub address mapped to a corresponding identifier, tt_portnumᵢ is the hub port number mapped to a corresponding identifier, tt_multiᵢ is 0 if the downstream hub supports one transaction translator or 1 if the downstream hub supports more than one transaction translator, tt_addrₗₒₒₖᵤₚ, tt_portnumₗₒₒₖᵤₚ, and tt_multiₗₒₒₖᵤₚ correspond to values within the hub-address field, the hub-port field, and the multi-transaction-translator field of the split packet request, respectively, and Matchᵢ returns 0 if the hub-specific information is not mapped to an identifier or 1 if the hub-specific information is mapped to an identifier.

43. A method according to claim 34, wherein the step of storing state information associated with the split packet request comprises storing the split packet request in the state memory.

44. A method according to claim 34, wherein the step of storing state information associated with the split packet request comprises updating data concerning a total number of asynchronous packets-in-progress.

45. A method according to claim 34, wherein the step of storing state information associated with the split packet request comprises updating data concerning a total number of periodic packets-in-progress.

46. A method according to claim 34, wherein the step of storing state information associated with the split packet request comprises updating data concerning a total number of bytes-in-progress.

47. A method according to claim 34, wherein the host controller implements a USB protocol.

48. A method according to claim 34, wherein the transaction translator is configured to operate according to the USB specification revision 2.0.

49. A system for tracking a state of a data forwarding means within a downstream hub comprising:
a means for receiving a split packet request defining a transaction, the split packet request including a plurality of fields containing hub-specific information;
a means for performing a lookup in an associative array using the hub-specific information to determine whether an identifier is allocated to the data forwarding means, the associative array mapping hub-specific information to an identifier;
a means for allocating a packet execution resource to the transaction associated with the split packet request; and
a means for storing in a storage location of a state memory state information associated with the split packet request to reflect the transaction defined by the split packet request, the storage location having an address defined by the identifier and the packet execution resource.
